(19) United States
(12) Patent Application Publication
(10) Pub. No.: US 2007/0022607 A1
(43) Pub. Date: Feb. 1, 2007

(54) SHAVER

(75) Inventors: Toshihiro TAKEUCHI, Osaka (JP); Kazuyuki OUCHI, Osaka (JP); Takeshi MATSUSAKA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC WORKS, LTD., Osaka (JP)

(21) Appl. No.: 11/459,685

(22) Filed: Jul. 25, 2006

(30) Foreign Application Priority Data
Jul. 29, 2005 (JP) 2005/221826
Mar. 28, 2006 (JP) 2006/089575

(51) Int. Cl. B26B 19/02

(52) U.S. Cl. 30/43.92

(57) ABSTRACT

It is possible to change a shaving area width that can be shaved at a time in accordance with a shaving portion, and to swiftly cut hair. The shaver includes a plurality of outer blade frames which hold a blade block for cutting hair. The outer blade frames are arranged in a direction Y intersecting with a moving direction X of a movable blade of the blade block. At least one of the outer blade frames can slide in the moving direction X of the movable blade from an initial position. The shaver has a fixing unit which fixes the outer blade frame at a sliding position.

### CROSS REFERENCE TO RELATED APPLICATIONS

This application is based upon and claims the benefit of priority from prior Japanese Patent Application P2005-221826 filed on Jul. 29, 2005 and prior Japanese Patent Application P2006-08957 filed on Mar. 28, 2006; the entire contents of which are incorporated by reference herein.

### BACKGROUND OF THE INVENTION

The present invention relates to a shaver for cutting hair.

FIGS. 1 and 2 show a conventional shaver 4′ described in Japanese Patent Application Laid-open No 2005-40358 (Patent Document 1). In the shaver 4′, a shaver main body 9′ is provided at its upper portion with a plurality of outer blade frames 2′ which hold a blade block 1′ for cutting hair, and the outer blade frames 2′ are arranged in a direction intersecting with a moving direction X of a movable blade of the blade block 1′.

According to the shaver disclosed in the Patent Document 1, the outer blade frames 2′ are mounted on the shaver main body 9′ such that the outer blade frames 2′ can independently float or swing in accordance with pushing forces against a skin, and if a user grasps the shaver main body 9′ and pushes the blade block 1′ against his or her skin, the outer blade frames 2′ float or swing along the unevenness or shape of the skin in a corresponding manner with respect to the unevenness or shape of the skin. According to the conventional shaver 4′, however, a shaving area width M which can be shaved at a time is the width of the longitudinal direction of the blade block shown in FIG. 1. Therefore, with a shaver 4′ having a long blade block 1′ in the X direction in FIG. 1, it is not possible to shave a narrow portion such as an armpit, and with a shaver 4′ having a short blade block 1′ in the X direction in FIG. 1, on the other hand, it is possible to shave the narrow portion such as the armpit, but since the area that can be shaved at a time is narrow when a wide portion such as a leg or an arm is shaved, there is a problem that it takes time to shave and ease of operation is poor.

### SUMMARY OF THE INVENTION

The present invention has been achieved in view of the conventional problem, and it is an object of the invention to provide a shaver having excellent operating ease and capable of changing a shaving area width that can be shaved at a time in accordance with a shaving portion and capable of swiftly shaving

To achieve the above object, the shaver according to the present invention includes a plurality of outer blade frame 2 each having a blade block 1 for cutting hair, the outer blade frame 2 are arranged in a direction perpendicular to a moving direction of a movable blade 39 of the blade block 1, at least one of the outer blade frame 2 can slide in the moving direction of the movable blade 39 from an initial position, and the shaver further includes a fixing unit 3 for fixing the outer blade frame 2 at a sliding position.

With this configuration, when hair in a portion having a narrow shaving area such as the armpit is to be cut, when hair in a portion where the shaving area width is narrow such as an armpit is to be cut, if the arranged outer blade frames 2 are used in the initial position, the shaver can easily come into contact with a skin even in a narrow portion such as the armpit and hair can be cut smoothly and swiftly and operability is excellent, and when hair in a portion having wide shaving area such as a leg and an arm is to be cut, the operating unit 2 are slid and the shaving area width M that can be shaved at a time by the shaver 4 is widened, the amount of hair that can be shaved with one stroke is increased and hair can be cut swiftly, and since the outer blade frames 2 are fixed by the fixing unit 3 at the sliding position, hair can be cut in a state where the shaving area width M set by the slide is maintained when the outer blade frames 2 are slid and the shaver is used, and hair can be cut stably and reliably.

It is preferable that the outer blade frame 2 can slide in different directions.

With this configuration, the shaving area width M that can be shaved at a time can efficiently be widened, the amount of hair that can be shaved with one stroke is increased and hair can be cut swiftly.

It is preferable that at least one of the outer blade frames 2 can slide, each of the outer blade frame 2 has the blade block 1, the movable blade 39 of the blade block 1 is driven by one drive source.

With this configuration, even though at least one of the arranged outer blade frames 2 can slide in the moving direction of the movable blade 39, only one drive source suffices, the weight is reduced, the number of members is reduced and the structure can be simplified.

It is preferable that a drive element a which is driven by a drive source and which reciprocates the movable blade 39 is divided into a drive source-side drive element portion 42 on a drive source side and a movable blade-side drive element portion 41 on a movable blade-side, the movable blade-side drive element portion is mounted on the drive source-side drive element portion 42 such that the movable blade-side drive element portion can slide in a reciprocating direction of the movable blade 39.

With this configuration, it is possible to employ a structure for preventing hair chips and water from entering the shaver main body 9 at a portion of the drive source-side drive element portion 42 which is driven by the drive source and which reciprocates and thus, the movable blade-side drive element portion 41 can slide irrespective of the structure which prevents hair chips and water from entering the shaver main body 9, the structure of the sliding portion can be simplified, the entire shaver can be reduced in size and the operability is enhanced.

It is preferable that a plurality of movable blade-side drive element portions slide in association by a drive element associating unit.

If one of the movable blade-side drive element portions 41 is slid, the other movable blade-side drive element portion 41 call slide in association, and the operability is enhanced.

It is preferable that the shaver further includes a drive element connecting nit 44 which connects the movable blade-side drive element portion 41 and the drive source-side drive element portion 42, and a spring member 45 which slides the movable blade-side drive element portion from the initial position to a sliding position or from the sliding position to the initial position with respect to the drive source-side drive element portion 42.

With this configuration, the movable blade 39 can be reciprocated by driving force from the drive source in a state where the movable blade-side drive element portion 41 and the drive source-side drive element portion 42 are connected to each other by the drive element connecting unit 44, and the movable blade-side drive element portion 41 can slide with respect to the drive source-side drive element portion 42 in a state where the connection established by the drive element connecting unit 44 is released, and if the connection established by the drive element connecting unit 44 is released, the movable blade-side drive element portion 41 can slide from the initial position to the sliding position or from the sliding position to the initial position with respect to the drive source-side drive element portion 42 by the spring member 45, and the sliding operation can be easily carried out.

It is preferable that the movable blade-side drive element portion 41 and the drive source-side drive element portion 42 can slide by a rail structure including a recess 46 and a protrusion 47, the rail structure is provided at its end with a stopper 48 for a sliding motion.

With this configuration, the movable blade-side drive element portion 41 can be allowed to slide with respect to the drive source-side drive element portion 42 with a simple structure, and the sliding motion can be stopped at the connection position reliably.

It is preferable that the drive element connecting unit 44 includes a drive element lock member 49 which is biased by a spring provided on the drive source-side drive element portion 42, and a lock hole 50 into which the drive element lock member 49 provided on the movable blade-side drive element portion 41 can be fitted, the drive element lock member 49 is fitted into the lock hole and a position of slide of the movable blade-side drive element portion 41 is fixed.

With this configuration, the movable blade-side drive element portion 41 can be connected to the drive source-side drive element portion 42 at the sliding position reliably with a simple structure.

It is preferable that the plurality of outer blade frame 2 slide by an outer blade frame 2 associating unit 51 in association.

With this configuration, if one of the outer blade frames 2 slides, the other outer blade frames 2 slides in association by the outer blade frame associating unit 51, a using mode in which the shaving area width M that can be shaved at a time by the shaver 4 is widened and a using mot in which the shaving area width M is narrowed can be established, the using mode can easily be changed and the operability is enhanced.

It is preferable that the outer blade frame 2 is mounted on a shaver main body 9 such that the outer blade frame 2 can slide in a reciprocating direction of the movable blade 39, the fixing unit 3 of the outer blade frame 2 includes a frame lock member 53 biased by a spring provided on the side of the shaver main body 9, and a lock hole 50 into which the frame lock member 53 provided on the outer blade frame 2 can be fitted, the frame lock member 53 is fitted into the lock hole 50 and a slide position of the outer blade frame 2 is fixed.

With this configuration, the sliding position of the outer blade frame 2 which slides can reliably be fixed with a simple structure.

It is preferable that the shaver further includes an arrangement direction position holding unit which holds a positional relationship of the arranged outer blade frame 2 in an arrangement direction.

With this configuration, it is possible to prevent the arranged outer blade frames 2 from opening and narrowing in the arrangement direction by the arrangement direction position holding unit 55, the shaver can be used stably and the sliding motion can be stably and smoothly carried out in the using mode in which the shaving area width M is widened and in the using mode in which the shaving area width M is narrowed.

It is preferable that the outer blade frame 2 is provided with a connecting member 56 which detachably connects the movable blade-side drive element portion 41 and the outer blade frame 2 with each other, the outer blade frame 2 and the movable blade-side drive element portion 41 can slide simultaneously in a state where the outer blade frame 2 and the movable blade-side drive element portion 41 are connected to each other by the connecting member 56, and the movable blade-side drive element portion 41 can reciprocate in the outer blade frame 2 in a state where the outer blade frame 2 and the movable blade-side drive element portion 41 are not connected to each other by the connecting member 56.

With this configuration, in a state where the movable blade-side drive element portion 41 and the outer blade frame 2 are connected to the outer blade frame 2 by the connecting member 56, the outer blade frame 2 and the movable blade-side drive element portion 41 can slide simultaneously by releasing the fixed state by the fixing unit 3, the using mode in which the shaving area width M is widened and the using mode in which the shaving area width M is narrowed can be switched with one operation, the operability is enhanced, the number of parts can be reduced with a simple structure, and the shaver can be made compact.

It is preferable that the shaver further includes a common operating unit 57 which releases the connection between the movable blade-side drive element portion 41 and the drive source-side drive element portion 42 established by the drive element connecting unit 44, releases the connection between the shaver main body 9 and the outer blade frame 2 established by the fixing unit 3 of the outer blade frame 2, and connects the movable blade-side drive element portion 41 and the outer blade frame 2 to each other by the connecting member 56.

With this configuration, when the outer blade frame 2 and the movable blade-side drive element portion 41 are slid in association, it is possible to release the connection by the drive element connecting unit 44, to release the connection by the fixing unit 3, and to connect by the connecting member 56 with one operation of the operating unit 57, the operating manner is enhanced and the operability is improved.

It is preferable that in a state where the outer blade frame 2 is slid in the moving direction of the movable blade 39 from the initial position, a shaving area width M established by the outer blade held by the arranged outer blade frame 2 is widened, the arranged outer blades are formed such that both ends of the shaving area width M project more than a central portion thereof.

With this configuration, when the shaving area width M is widened and hair of an arm or a leg is to be cut, the outer blade easily comes into close contact with a curved surface of the arm or the leg, unshaved portion is small, and hair can be cut swiftly.

It is preferable that the shaver further includes an output side gear 5 which outputs a driving force, a drive gear 6 to which rotation is transmitted from the output side gear 5 and which rotates, a drive element 8 which converts the rotation of the drive gear into a reciprocating motion through an eccentric cam 7 and which reciprocates the movable blade 39 of the outer blade frame 2, a plurality of output side gears, wherein the drive gear, the eccentric cam 7 and the drive element 8 slide together with the outer blade frame 2 , the driving force is transmitted to the drive gear 6 through different output side gears 5 in the initial position and the sliding position of the outer blade frame 2.

With this configuration, in a state where the outer blade frame 2 is slid, the driving force is transmitted and the movable blades 39 provided on the plurality of outer blade frames 2 can reciprocate, and the structure can be simplified.

### BRIEF DESCRIPTION OF THE DRAWINGS

FIG. 1 is a front view of a shaver of a conventional example;

FIG. 2 is a side view of the shaver of the conventional example;

FIG. 3 is a front vie w when an outer blade frame of a shaver according to the present invention is slid to elongate a shaving area width;

FIG. 4 is a front view when the outer blade frame of the shaver is located at an initial position and the shaving area width is short;

FIG. 5 is a side view of the shaver;

FIG. 6 is a partially omitted exploded perspective view of the shaver;

FIG. 7 is a front view of a driving force transmitting mechanism when the outer blade frame is slid to elongate the shaving area width,

FIG. 8 is a perspective view of the driving force transmitting mechanism portion when the outer blade frame is slid to elongate the shaving area width;

FIG. 9 is a partially omitted perspective view of the driving force transmitting mechanism portion when the outer blade frame is slid to elongate the shaving area width;

FIG. 10 is a front view of the driving force transmitting mechanism when the outer blade frame is located at an initial position and the shaving area width is narrow;

FIG. 11 is a perspective view of the driving force transmitting mechanism portion when the outer blade frame is located at the initial-position and the shaving area width is narrow;

FIG. 12 is a partially omitted perspective view of the driving force transmitting mechanism portion when the outer blade frame is located at the initial position and the shaving area width is narrow;

FIG. 13 is a front view when an outer blade frame of a shaver of another embodiment of the present invention is slid and a shaving area width is elongated;

FIG. 14 is a front view when the outer blade frame of the shaver is located at the initial position and the shaving area width is short;

FIG. 15 is a side view of the shaver;

FIG. 16 is a side sectional view of the shaver;

FIG. 17 is an exploded perspective view of a state where a housing is omitted;

FIG. 18 is a perspective view when the outer blade frame of the shaver is slid and the shaving area width is elongated in a state where the housing is omitted;

FIG. 19 is a front view when the outer blade frame of the shaver is slid and the shaving area width is elongated in a state where the housing is omitted;

FIG. 20 is a plan view when the outer blade frame of the shaver is slid and the shaving area width is elongated in a state where the housing is omitted;

FIG. 21 is a side view in a state where the housing is omitted;

FIG. 22 is a perspective view in a state where front and rear frame portions in FIG. 18 are omitted;

FIG. 23 is a front view in a state where front and rear frame portions in FIG. 19 are omitted;

FIG. 24 is a plan view in a state where front and rear frame portions in FIG. 20 are omitted;

FIG. 25 is a side view in a state where front and rear frame portions in FIG. 21 are omitted;

FIG. 26 is a perspective view in a state where front and rear frame portions in FIG. 22 are omitted;

FIG. 27 is a front sectional view of a drive element connecting unit;

FIG. 28 is a front sectional view of a fixing unit for fixing the outer blade frame;

FIG. 29 is a plan sectional view of a connecting member portion;

FIG. 30 a is a perspective view of a state where the front movable blade-side drive element portion in FIG. 26 is omitted;

FIG. 31 is a perspective view of a state where the front frame main body portion is slidably mounted on a frame base;

FIG. 32 is a perspective view of a state where the front frame main body port ion and the rear frame main body portion are slidably mounted on the frame base;

FIG. 33A is a side sectional view of a portion where the rear frame main body portion is slidably mounted on the frame base, and FIG. 33B is a side sectional view of another portion;

FIG. 34A is a sectional view of a positional relationship between a drive element lock member and an operation button, and FIG. 34B is a sectional view of a positional relationship between a connecting member and the operation button;

FIG. 35 is a perspective view of a state where a drive source-side drive element portion is mounted on an upper base;

FIG. 36A is a partially omitted perspective view of a drive element, FIG. 36B is a sectional view, and FIG. 34C is an exploded perspective view;

FIG. 37 is a front view when an outer blade frame is slid and a shaving area width is elongated in a state where a housing of another embodiment of the invention is omitted;

FIG. 38 is a rear view when the outer blade frame is slid and the shaving area width is elongated in a state where the housing is omitted;

FIG. 39 is a perspective view when the outer blade frame is slid and the shaving area width is elongated in a state where the housing is omitted;

FIG. 40 is a perspective view of a taper guide portion provided on a main frame base;

FIG. 41 is a front view of the taper guide portion provided on the main frame base;

FIG. 42 is a perspective view of a taper guide portion provided on a front outer blade frame; and

FIG. 43 is a front view of the taper guide portion provided on the front outer blade frame.

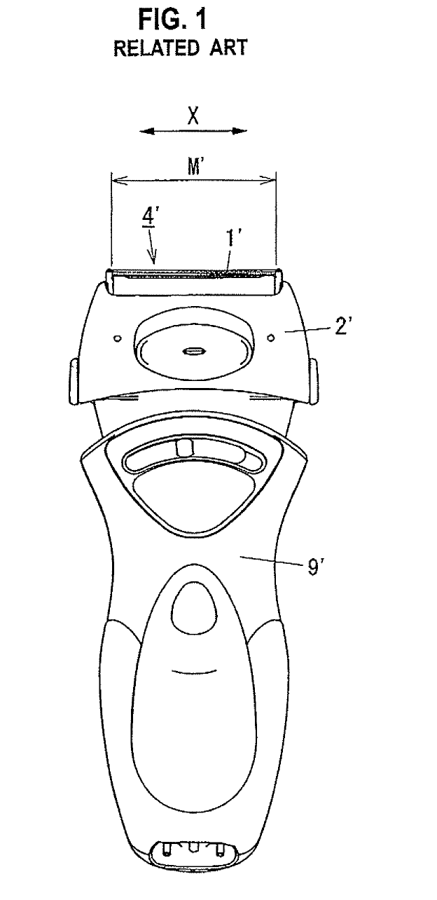

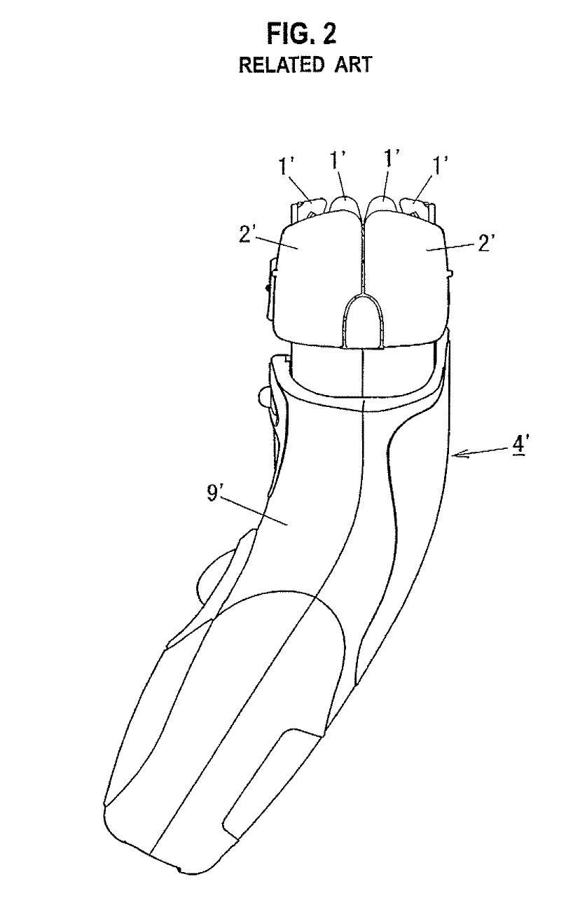

### DETAILED DESCRIPTION OF THE PREFERRED EMBODIMENTS

Embodiments of the present invention will be explained below with reference to the drawings.

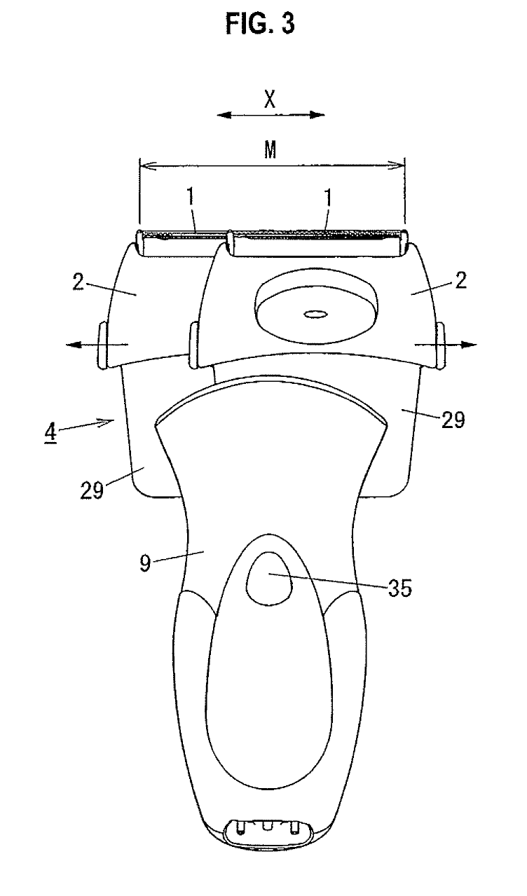

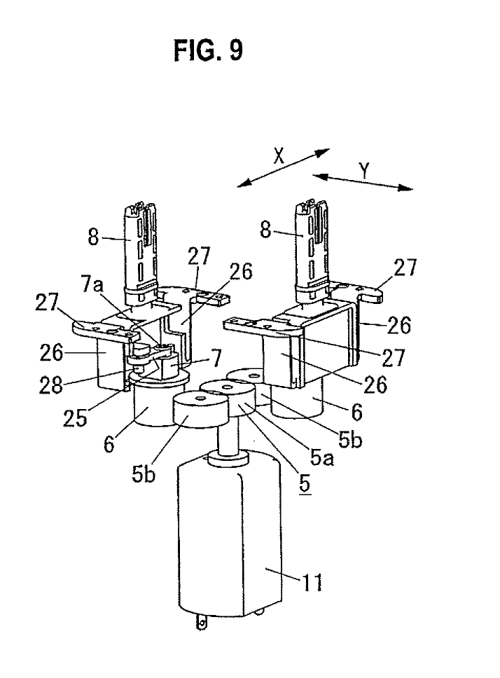

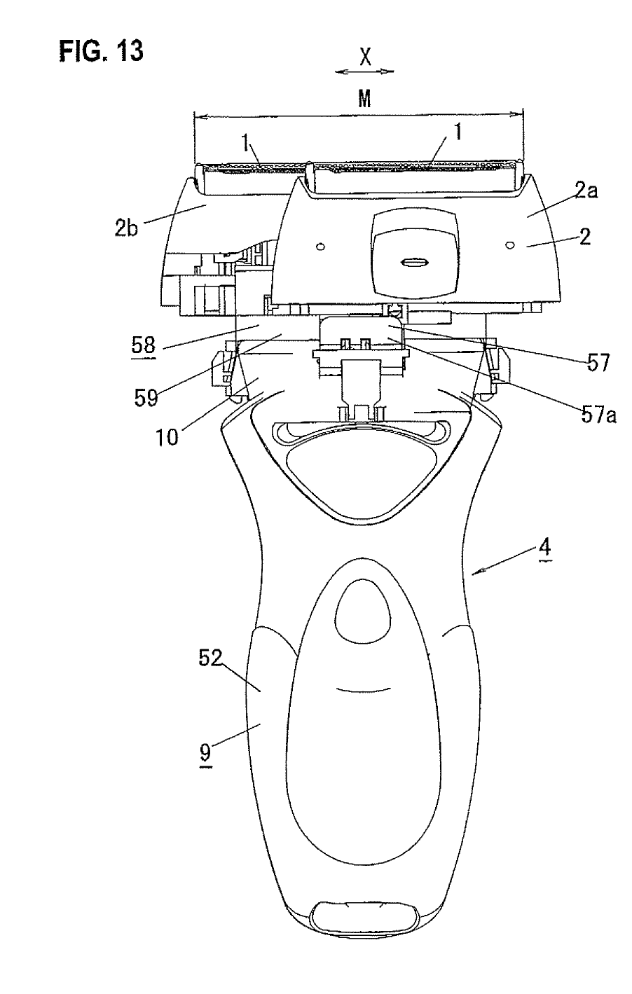

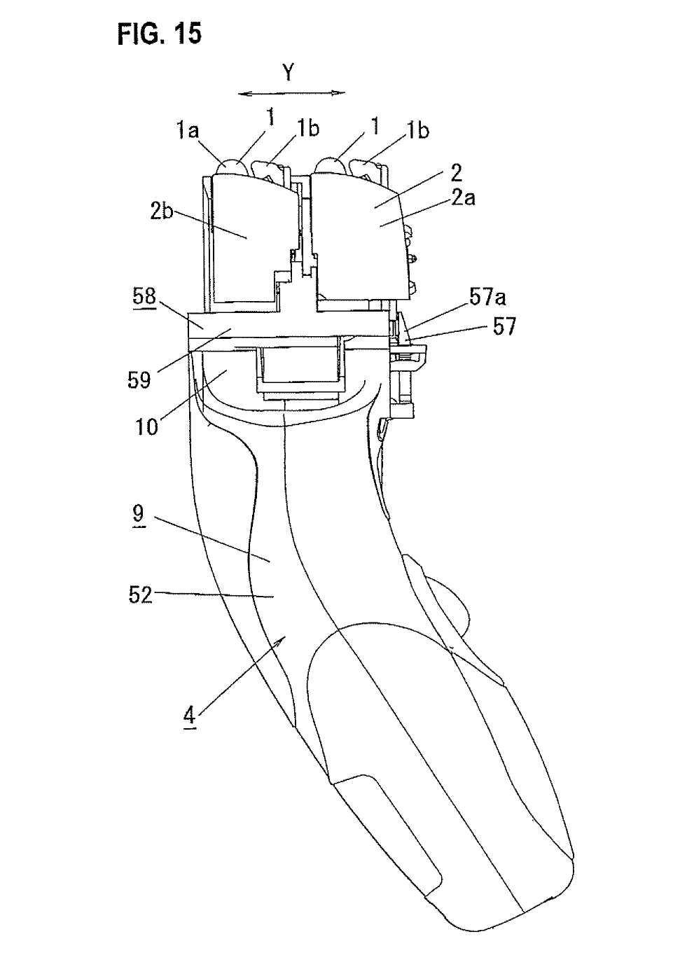

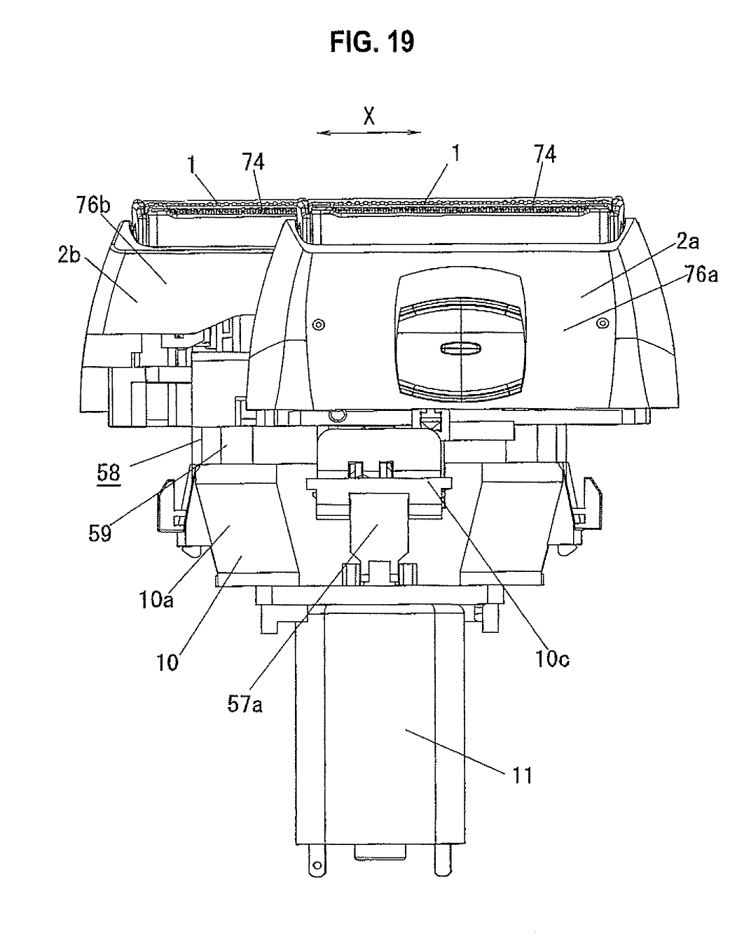

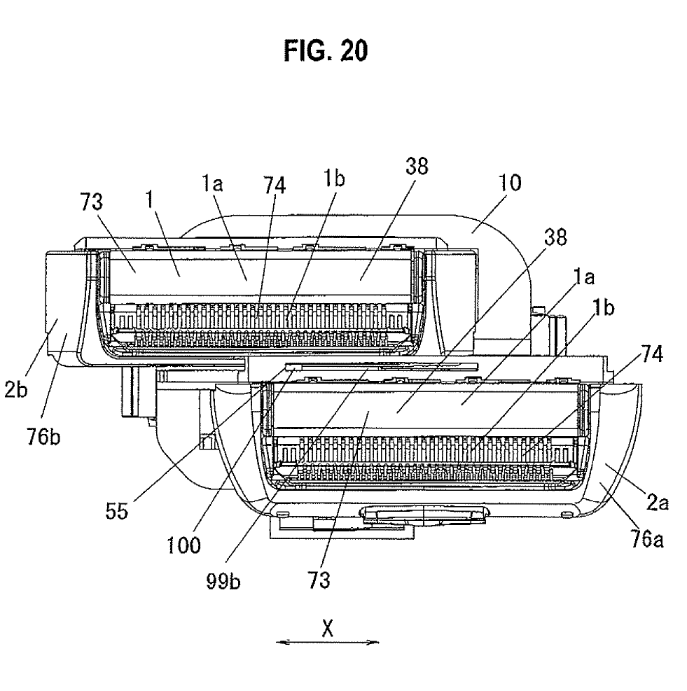

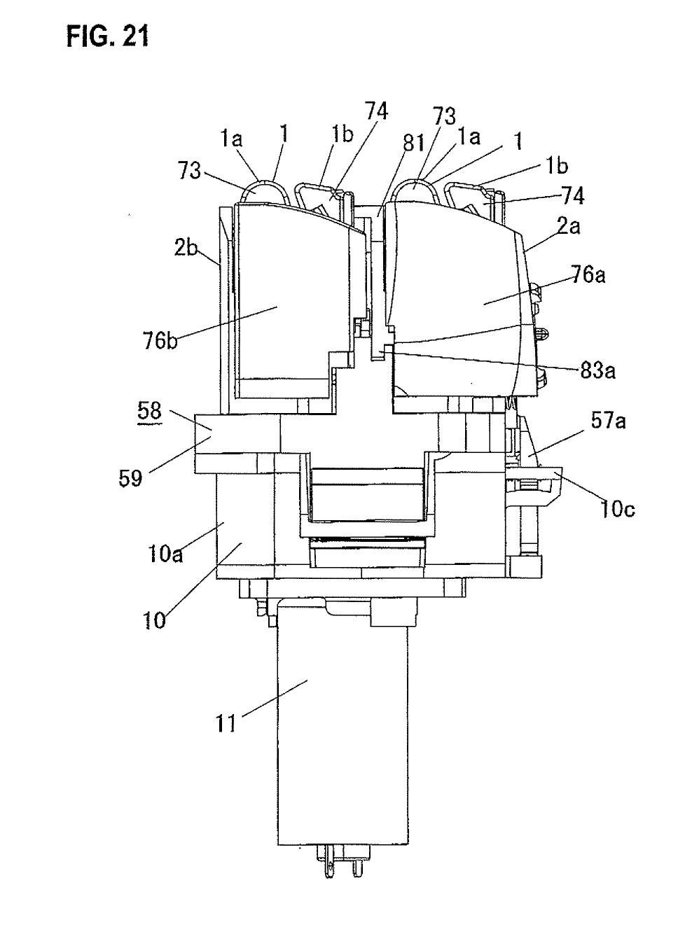

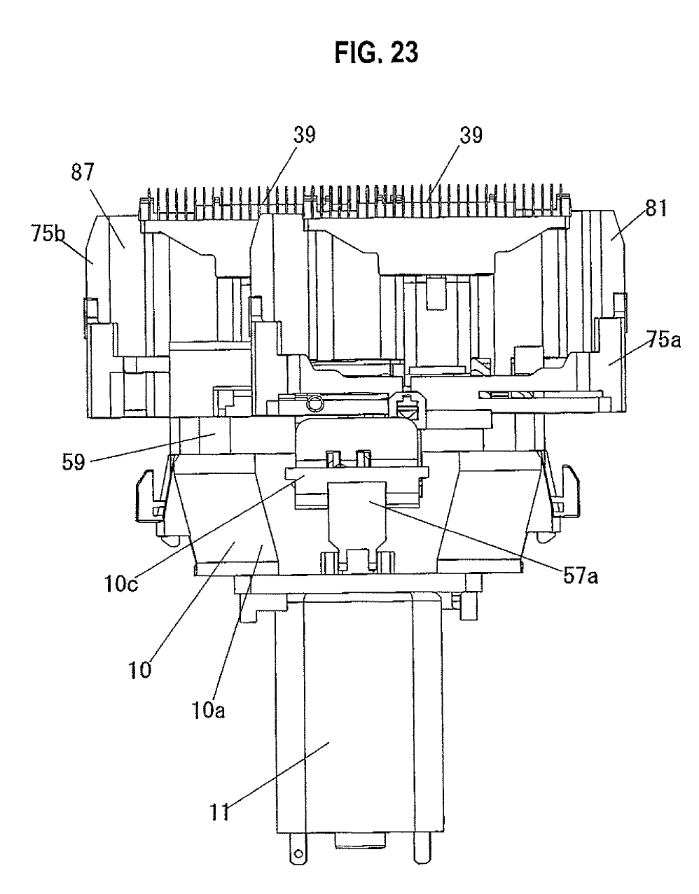

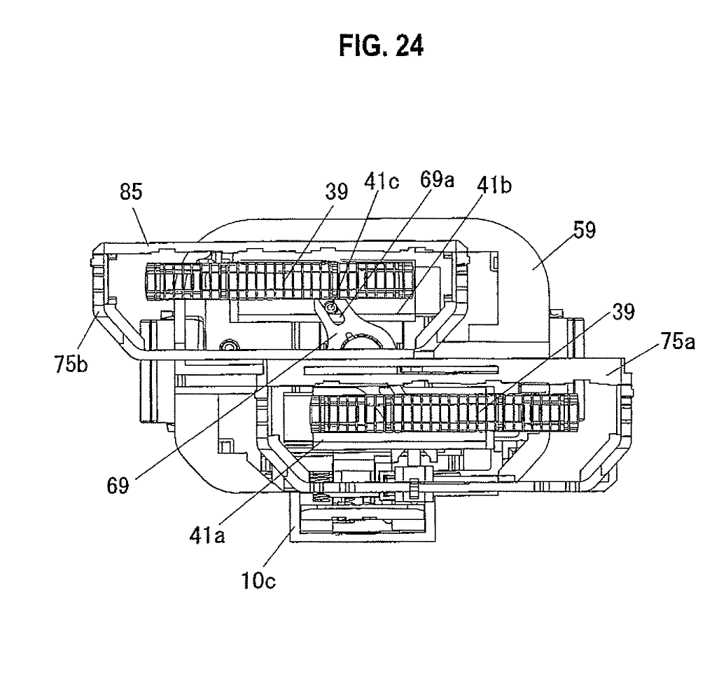

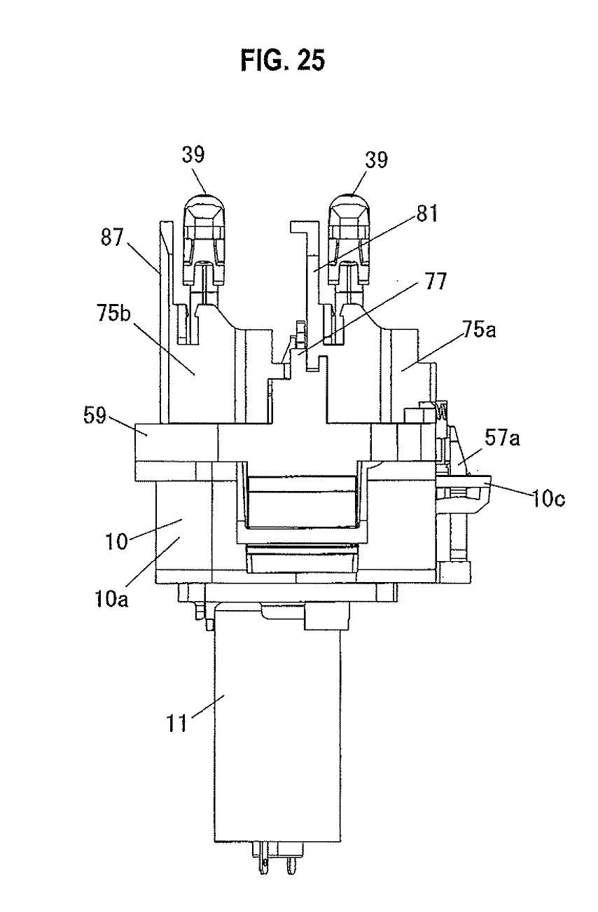

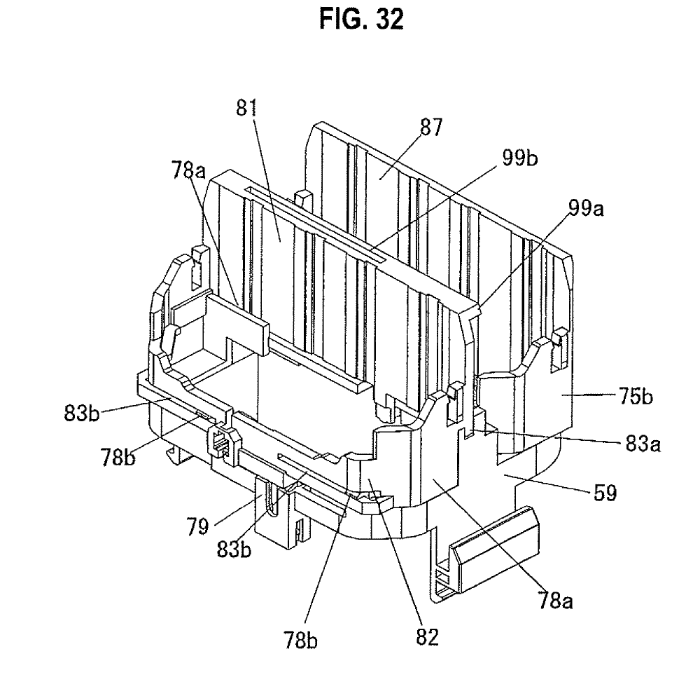

FIGS. 3 to 12 show one embodiment of the present invention, and FIGS. 13 to 36 show other embodiments of the invention.

First, the embodiment shown in FIGS. 3 to 12 will be explained.

As shown in FIGS. 3 to 5, a shaver 4 according to the present invention includes a shaver main body 9 which is a grip to be griped by a hand of a user, and a plurality of outer blade frames 2 provided on an upper portion of the shaver main body 9. The outer blade frames 2 hold a blade block 1 for cutting hair. The outer blade frames 2 are arranged in a direction intersecting with a moving direction X of a movable blade of the blade block 1. The moving direction of the movable blade is defined as X direction (lateral direction), and the arrangement direction of the outer blade frames 2 intersecting with the X direction is defined as Y direction (longitudinal direction). A direction intersecting with both the X direction and Y direction at right angles is defined as a vertical direction, a side of the shaver main body 9 closer to the blade block 1 is defined upside, and the opposite side is defined downside.

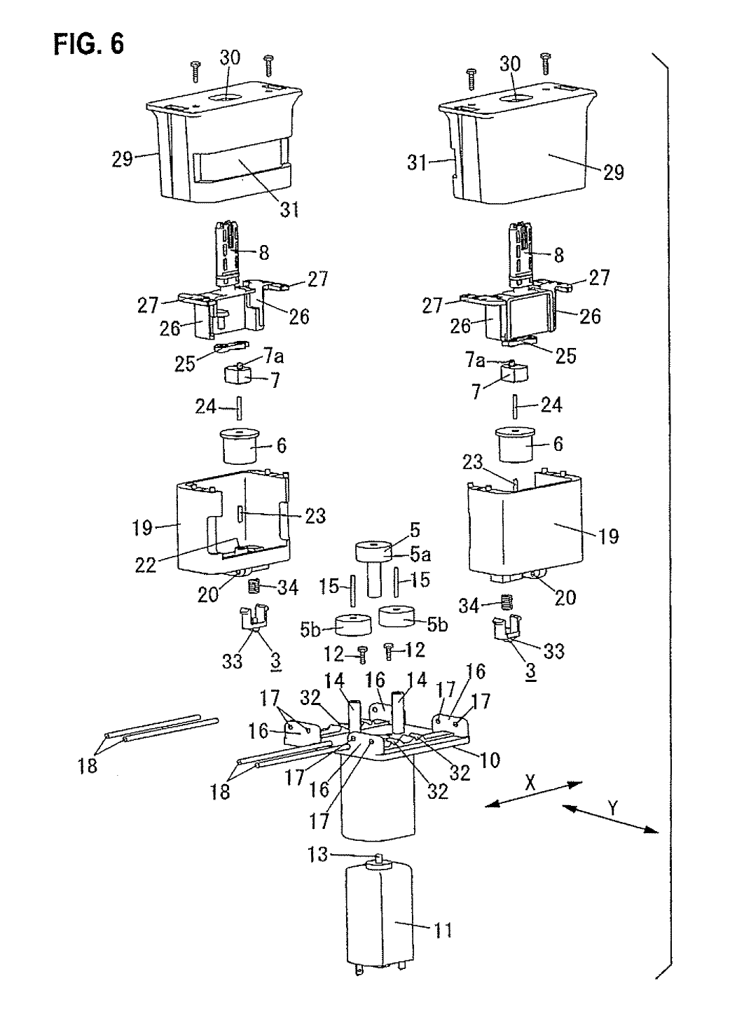

FIGS. 6 to 12 show one embodiment of a driving force transmitting mechanism of the present invention.

The shaver main body 9 has a housing 52 as a main body, and an upper base 10 is mounted on an upper portion of the housing 52.

A motor 11 is fixed to the upper base 10 by screws 12. An output side main gear 5a is press fitted and fixed to an output shaft 13 of the motor 11. Bearing bosses 14 project from the upper base 10, and shafts 15 as rotation fulcrums of output side auxiliary gears 5b and 5b are press fitted and fixed to bearing bosses 14. The output side auxiliary gears 5b and 5b are engaged with the out put side main gear 5a so that power of the output side main gear 5a is transmitted to the output side auxiliary gears 5b and 5b. In the embodiment shown in the attached drawings, the output side main gear 5a is located at a center portion of the upper base 10, and the output side auxiliary gears 5b and 5b are disposed on opposite sides of the output side main gear 5a in the X direction (lateral direction). The output side main gear 5a and the output side auxiliary gears 5b and 5b constitute output side gears 5. That is, in the present embodiment, total three output side gears 5, i.e., one output side main gear 5a and two output side auxiliary gears 5b and 5b are provided.

A pair of projections 16 project from opposite sides of upper surface of the upper base 10 in the Y direction (longitudinal direction) such as to be opposed to both ends in the X direction. Two slide shaft inserting holes 17 are formed in each of the pair of projections 16 which are opposed to each other in the X direction. A slide shaft 18 is inserted into each of the opposed slide shaft inserting holes 17 so that two slide shafts 18 extend between the opposed pairs of projections 16 In this manner, one set, i.e., two slide shafts la extend between the both sides of the upper base 10 in the Y direction.

Two slide holes 20 provided in lower ends of drive element bases 19 are slidably fitted into the one set, i.e., two slide shafts 18, the drive element base 19 are slidably mounted on the upper base 10 in the X direction so that the drive element bases 19 are slidably mounted on both sides of the output side gears 5 in the Y direction.

As shown in FIG. 6, each of the drive element base 19 is of a hollow structure. An upper side of the drive element base 19 and a side thereof facing the output side gear 5 are opened. A shaft 23 is press fitted and fixed to a boss 22 provided on the bottom of the follow interior of the drive element base 19. A drive gear 6 is pivotally supported by the shaft 23. An eccentric cam 7 having a balancer weight is fixed to each of the drive gears 6 through the shaft 24. One end of the drive arm 25 is rotatably supported on an eccentric shaft 7a (eccentric with respect to ration center of the drive gear 6) of the eccentric cam 7.

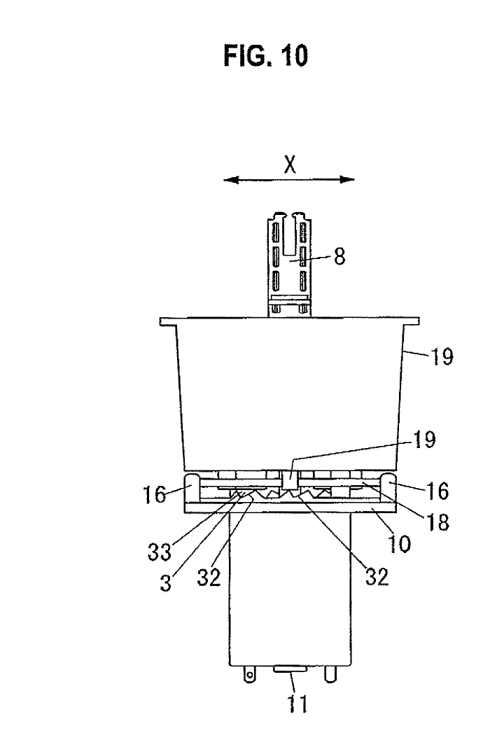

As shown in FIGS. 10 to 12, at a position (an initial position) where both the drive element bases 19 are arranged such that they are superposed on each other in the Y direction, the drive gears 6 provided on the drive element bases 19 are engaged with the output side main gear 5a of the plurality of output side gears 5. In this state, power from the output side main gear 5a is transmitted to both the drive gears 6.

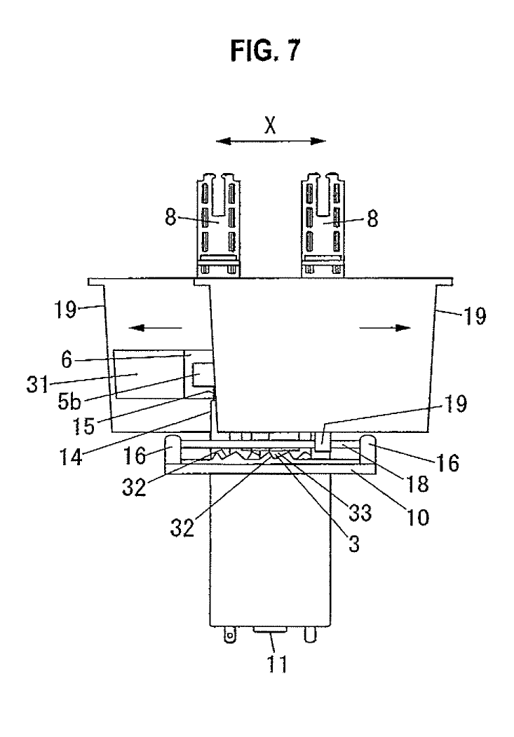

As shown in FIGS. 7 to 9, if both the drive element bases 19 are separated away from each other in the Y direction, one of the drive gears 6 is engaged with one of the output side auxiliary gears 5b and 5b and power is transmitted, and the other drive gear 6 is engaged with the one output side auxiliary gear 5b and power is transmitted.

Although it is not shown in the drawings, it only one of the drive element bases 19 is moved in the Y direction, one of the drive gears 6 is engaged with the one of the output side auxiliary gears 5b and 5b and power is transmitted, and the other drive gear 6 is engaged with the central output side main gear 5a and power is transmitted.

As shown in FIG. 6, a plurality of (two in the shown embodiment) retaining units 32 are provided on both sides of the upper surface of the upper base 10 in the X direction. A lock member 33 is vertically movably mounted on a lower end of each drive element base 19. The lock member 33 resiliently projects by a spring 34. As shown in FIG. 10, when the drive element base 19 is in the initial position, the lock member 33 is resiliently engaged with one of the retaining units 32, thereby fixing the drive element base 19 at the initial position. If an external force greater than the retaining force caused by the spring is applied, the drive element base 19 can be slid in the X direction against the spring. As shown in FIG. 7, if the lock member 33 resiliently engages another retaining unit 32 at a predetermined slide position, the drive element base 19 can be fixed to the predetermined slide position. The retaining units 32 and the lock member 33 constitute the fixing unit 3.

A drive element 8 is mounted on each of the drive element bases 19. The drive element a is provided at its both sides with fixing units 27 through the resilient pieces 26. A lower end of the drive element 8 is inserted into a gap of the drive element base 19 and the fixing units 27 located on the both sides in the X direction are fixed to both edges of upper openings of the drive element bases 19 in the X direction, thereby mounting the same on the drive element base 19 such that it can be moved only in the X direction by the resilient piece 26. The other end of the drive arm 25 is rotatably supported by a shaft portion 28 provided on the drive element 8. Thus, if the drive gear 6 rotates, the rotation motion is converted into a straight reciprocating motion through the eccentric cam 7 and the drive arm 25, and the drive element 8 is reciprocated only in the X direction.

As described above, the drive element base 19 can move in the X direction, and a frame mounting stage 29 is fitted over the drive element base 19 as shown in FIGS. 7, 8, 10, and 11. An upper portion of each of the drive elements 8 projects upward from a hole 30 of the frame mounting stage 29. The hole 30 has such a size that the reciprocating motion of the drive element 8 is not hindered. An opening 31 is formed in a side surface on the frame mounting stage 29 facing the output side gear 5.

The outer blade frames 2 are respectively detachably mounted on the plurality of (two in the shown embodiment) frame mounting stages 29 arranged and mounted in the Y direction.

The blade block 1 for cutting hair is supported on the outer blade frame 2. The blade block 1 is provided with blades for cutting hair. The blades include an outer blade and a movable blade (an inner blade). The movable blade is detachably connected to an upper portion of the drive element, and the movable blade reciprocates by the reciprocating motion of the drive element 8 in the X direction. The movable blade cuts hair which is introduced from the hole formed in the outer blade.

In the embodiment shown in the accompanying drawings, the outer blade frame 2 has two blade blocks 1, i.e., a short hair cutting blade block la for cutting short hair and a long hair cutting blade block 1b for cutting long hair.

The short hair cutting blade block la includes an outer blade by a net blade. In a state where a movable blade (an inner blade for cutting short hair) connected to an upper end of the drive element 8 is resiliently pushed against a lower surface side of the net blade by a spring material, the drive element 8 reciprocates in the X direction as described above, the movable blade reciprocates in the X direction, and short hair introduced from net holes of the net blade is cut.

The long hair cutting blade block 1b includes an outer blade by a slit blade. A movable blade for cutting long hair (an inner blade for cutting long hair) is resiliently pushed against a lower surface of the slit blade by a spring material. The movable blade is connected to the drive element 8 or the inner blade of the short hair cutting blade block la through an associating portion (not shown). If the drive element 8 reciprocates in the X direction as described above, the movable blade for cutting long hair reciprocates in the X direction, and long hair introduced from the slit holes of the slit blade is cut.

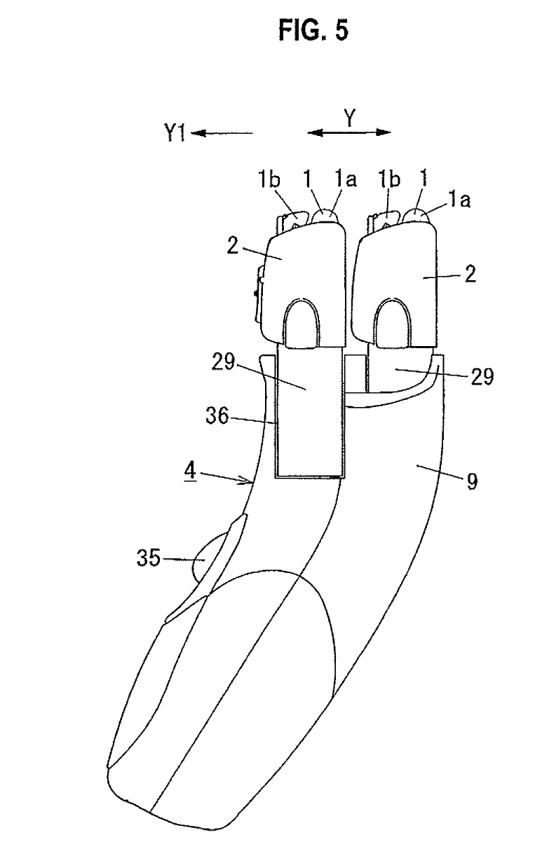

As shown in FIGS. 3 to 5, if the Y direction is defined as the longitudinal direction, the shaver main body 9 which becomes a grip to be grasped by a user is provided at its front surface with an operation switch 35 for turning the motor 11 ON and OFF. If the X direction is defined as the lateral direction, a side front opening 36 shown in FIG. 5 is formed in a front portion of an upper portion of one of left and right sides (i.e., both side surfaces in the X direction). Of the drive element bases 19 arranged in the longitudinal direction which is the Y direction from the side front opening 36, when a portion of the front side drive element base 19 is slid in the X direction (leftward or rightward), the portion of the drive element base 19 can project outward from the side front opening 36. Although it is not shown in the drawings, side rear opening (not shown) is formed in a rear portion of an upper portion of the other side surface of the left and right side surfaces of the shaver main body 9. When a portion of the rear drive element base 19 of the drive element bases 19 arranged in the longitudinal direction which is the Y direction from the side rear opening slides in the X direction (rightward or leftward), the portion of the drive element base 19 can project outward from the side rear opening. When the X direction is the lateral direction and the Y direction is the longitudinal direction, the X direction intersects with both the Y direction which is the Y direction and the vertical direction at right angles, and the Y direction intersects with both the X direction which is the lateral direction and the vertical direction at right angles.

The shaver main body 9 which becomes the grip becomes a surface where a thumb is located when the front surface side on which the operation switch 35 is provided is grasped by a hand. Normally, in a state where the shaver main body 9 is grasped by the hand, the operation switch 35 provided on the front surface is operated by the thumb located on the front surface. When the shaver is used, a user grasps the shaver main body 9 such that the thumb is located on the side of the front surface and in this state, the blade block 1 is brought into contact with a skin of the user, and the shaver is moved such that the side thereof on which the thumb is located comes front in the advancing direction. Therefore, of the Y direction which is the longitudinal direction, the Y1 direction is a using direction of the shaver 4 (moving direction of the shaver 4 when the shaver is used) (see FIG. 5).

The long hair cutting blade block 1b of each of the short hair cutting blade block la and the long hair cutting blade block 1b arranged on each of the outer blade frames 2 in the Y direction is closer to the front side as compared with the short hair cutting blade block la with respect to the using direction (Y1 direction) of the shaver 4.

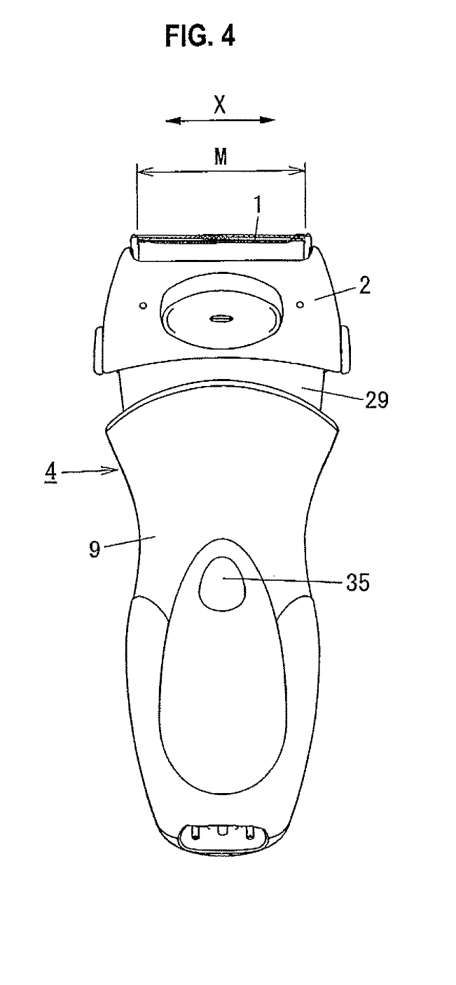

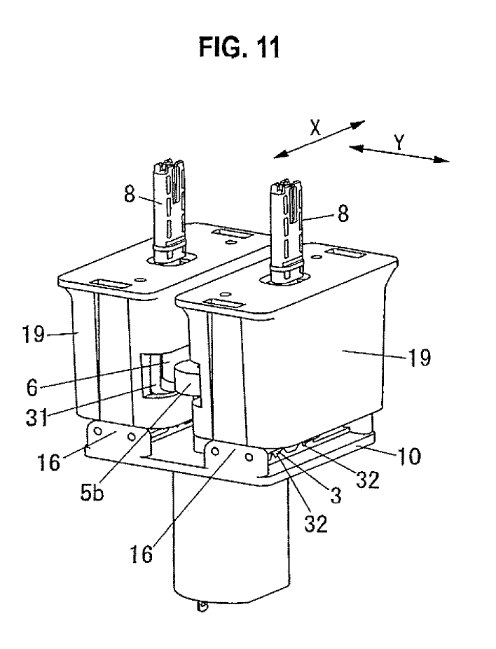

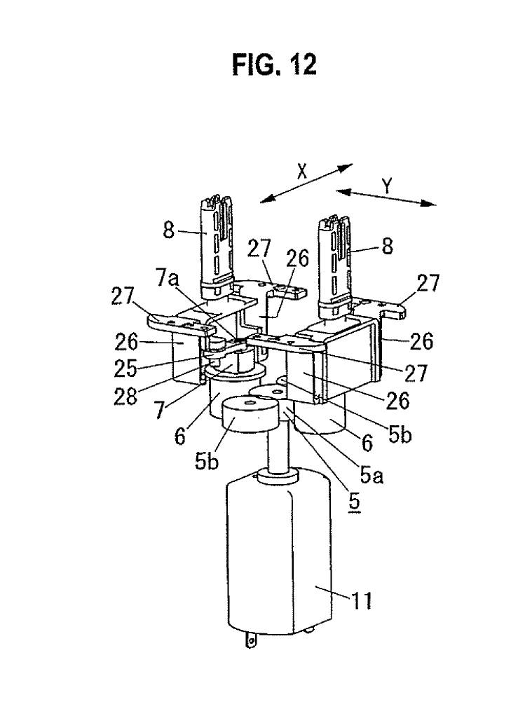

According to the shaver 4 of the present invention having the above-described structure, when hair in a portion of a human body having a narrow shaving width such as an armpit is to be cut, as shown in FIG. 4, and the shaver is used in a state where the plurality of outer blade frames 2 arranged in the Y direction are located in the initial positions. In the initial position, the plurality of outer blade frames 2 are arranged in the Y direction without deviating in the X direction, the plurality of drive element bases 19 (frame mounting stages 29 fitted over the drive element bases 19) are arranged in the Y direction without deviating in the X direction as shown in FIGS. 10 and 11, and the lock member 33 is resiliently engaged with one of the retaining units 32, and the drive element base 19 is fixed in the initial position. In the initial position, as shown in FIG. 12, the drive gears 6 provided on the drive element bases 19 located on both sides (longitudinally both sides) are engaged with the central output side main gear 5a in the X direction (lateral direction) of the three output side gears 5, rotation of the motor is transmitted to each drive gear 6 through the central output side main gear 5a. The movable blade of each blade block 1 provided on each outer blade frame 2 is reciprocated to cut hair on a portion of the shaving area such as the armpit. The state where the plurality of outer blade frames 2 arranged in the Y direction are located in the initial position is the using mode in which the shaving area width M where the hair can be shaved at a time by the entire blade blocks 1 provided on the outer blade frames 2 is the narrowest (shortest), and the hair in the narrow shaving area such as the armpit can effectively be cut.

In a state where the outer blade frames 2 are located in the initial position, hair is shaved by the short hair cutting blade block 1a and the long hair cutting blade block 1b arranged on each outer blade frame 2. If the shaver 4 is moved in the Y1 direction which is the using direction in a state where the short hair cutting blade block 1a and the long hair cutting blade block 1b provided on each the outer blade frame 2 are pushed against a skin, long hair is cut short by the long hair cutting blade block 1b located in front of the front outer blade frame 2 and then, the short hair is cut by the short hair cutting blade block 1a located in the rear of the front outer blade frame 2 and then, not yet been cut hair by the front outer blade frame 2 is cut by the front long hair cutting blade block 1b in font of the rear outer blade frame 2 and then, this short hair is cut by the short hair cutting blade block 1a located behind the rear outer blade frame 2, and hair in the narrow shaving area such as the armpit is effectively cut in many stages.

Next, when a wide portion such as a leg or an arm is to be shaved, the outer blade frame 2 is slid in the X direction, the outer blade frame 2 is deviated in the X direction as shown in FIG. 3, the shaving area width M that can be shaved at a time by the entire blade block 1 is elongated and used. The lock member 33 resiliently engages other retaining unit 32 that is different from the initial position of the retaining units 32, and the drive element base 19 is fixed to the initial position. Therefore when the shaving area width M that can be shaved at a time is elongated and used, the shaving area width M can be used in a state where the shaving area width M is held at a predetermined length.

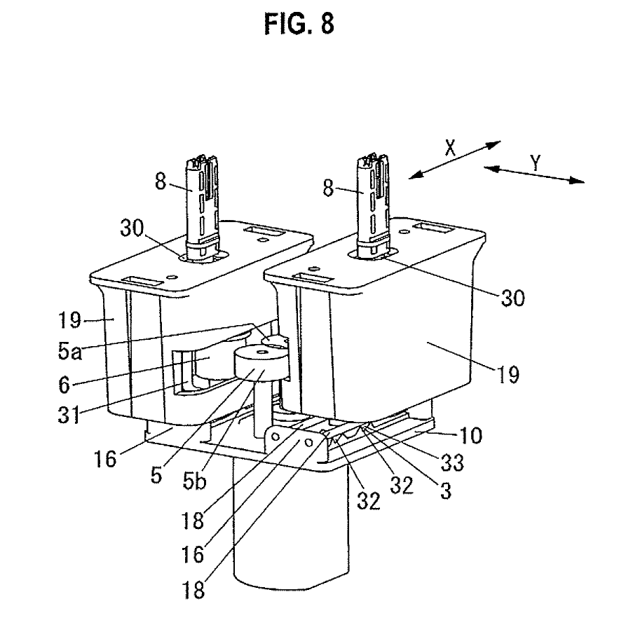

In a state where the outer blade frame 2 is slid in the X direction and the shaving area width M is elongated, as shown in FIG. 8, the drive gear 6 provided on one of the drive element bases 19 located on both sides (longitudinally both sides) in the Y direction is engaged with one of the output side gears 5 on the both sides in the X direction (lateral direction) of the three output side gears 5 (i.e., one of the left and right output side auxiliary gears 5b and 5b) as shown in FIG. 8, the drive gear 6 provided on the other drive element base 19 is engaged with the other one of the output side gears 5 on the both sides in the X direction (lateral direction) of the three output side gears 5 (i.e., other one of the left and right output side auxiliary gears 5b and 5b), rotation of the motor is transmitted to the drive gears 6 through the left and right output side auxiliary gears 5b and 5b, the movable blades of the blade blocks 1 provided on the outer blade frames 2 are reciprocated to cut hair on a narrow shaving area such as an armpit.

If the shaving area width M is elongated and used in this manner, the amount of hair which can be shaved with one stroke is increased and the shaving operation can be carried out quickly. Even when the outer blade frame 2 is slid in the X direction and the shaving area width M is elongated and hair is cut, since the outer blade frames 2 are respectively provided with the long hair cutting blade block 1b and the short hair cutting blade block 1a and the long hair cutting blade block 1b is located in front of the short hair cutting blade block 1a with respect to the using direction of the shaver 4, if the shaver 4 is moved in the Y1 direction which is the using direction in a state where the short hair cutting blade block 1a and the long hair cutting blade block 1b provided on the outer blade frames 2 are pushed against a skin, long hair is cut by the long hair cutting blade block 1b located in front of the outer blade frame 2, the shortly cut hair is cut short by the short hair cutting blade block la located in the rear of the outer blade frame 2 and thus, hair can be cut in two stages by the long hair cutting blade block 1b and the short hair cutting blade block 1a over the entire shaving area width M, and the cutting operation can be carried out effectively.

Here, in the embodiment shown in the accompanying drawings, the front and rear two outer blade frames 2 are slid in different directions from each other (one of the outer blade frames 2 is slid in the forward and the other one is slid in rightward). With this the shaving area width M that can be shaved at a time efficiently can be elongated (long), the amount of hair that can be shaved with one stroke is increased, and the shaving operation can be carried out quickly.

If both the outer blade frames 2 can slide in the X direction and both the outer blade frames 2 are slid in different directions to widen the shaving area width M that can be shaved at a time and only one of the outer blade frames 2 is slid, the shaving area width M can have an intermediate length of the shaving area width M shown in FIG. 3 and the shaving area width M shown in FIG. 4.

Although the two outer blade frames 2 can move in the X direction in the embodiment, it is only necessary that at least one of the plurality of outer blade frames 2 arranged in the Y direction can slide, and of the plurality of outer blade frames 2, an outer blade frame 2 which does not slide and an outer blade frame 2 which slides can be arranged in the Y direction.

When the outer blade frame 2 is slid in the X direction, a user may pinch the outer blade frame 2 itself with fingers and slide the same, or a sliding operation mechanism for sliding the outer blade frame 2 may be provided, and the outer blade frame 2 may be slid in the X direction by operating a slide operating unit provided on the shaver main body 9.

Next, an embodiment shown in FIGS. 13 to 36 will be explained.

As shown in FIGS. 13 to 16, a shaver 4 of the embodiment includes a shaver main body 9 which is a grip to be griped by a hand of a user, and a plurality of outer blade frames 2 provided on an upper portion of the shaver main body 9. The outer blade frames 2 hold a blade block 1 for cutting hair. The outer blade frames 2 are arranged in a direction intersecting with a moving direction X of a movable blade of the blade block 1. The moving direction of the movable blade 39 is defined as X direction (lateral direction), and the arrangement direction of the outer blade frames 2 intersecting with the X direction is defined as Y direction (longitudinal direction). A direction intersecting with both the X direction and Y direction at right angles is defined as a vertical direction, a side of the shaver main body 9 closer to the blade block 1 is defined upside, and the opposite side is defined downside.

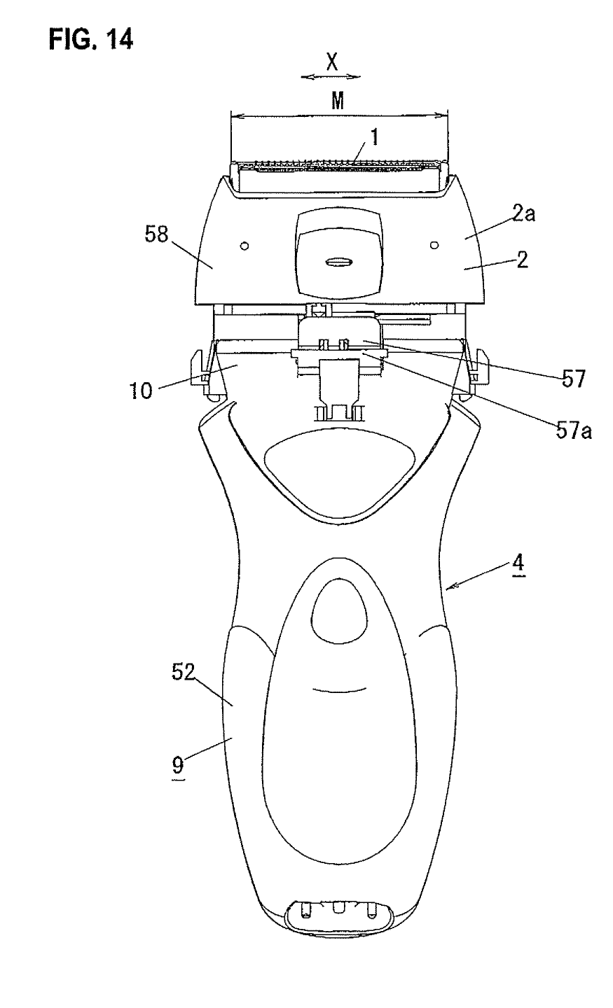

In the following embodiments also, explanation of usage and effect in a state where outer blade frames 2 are slid in the X direction and the shaving area width M is elongated as shown in FIG. 13, and explanation of usage and effect in a state where the shaving area width M is elongated as shown in FIG. 14 are the same as those of the previous embodiment. Therefore, explanation concerning this point will be omitted from the following embodiment and concrete mechanisms will be explained below.

The shaver main body 9 has a housing 52 as a main body, and an upper base 10 is mounted on an upper portion of the housing 52.

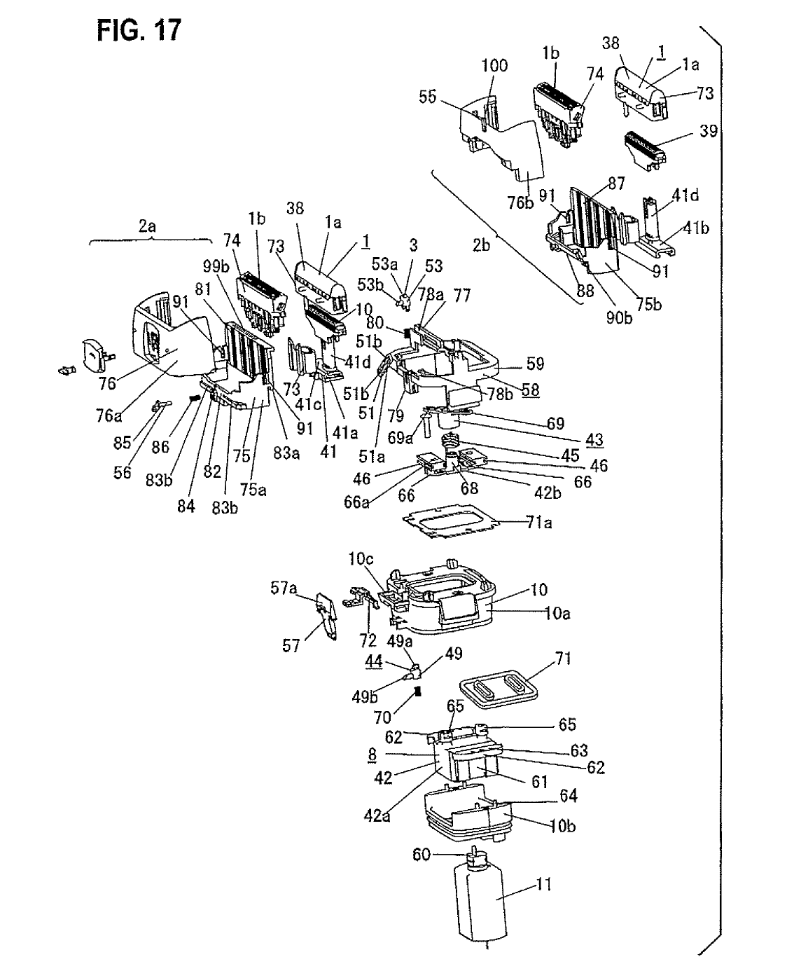

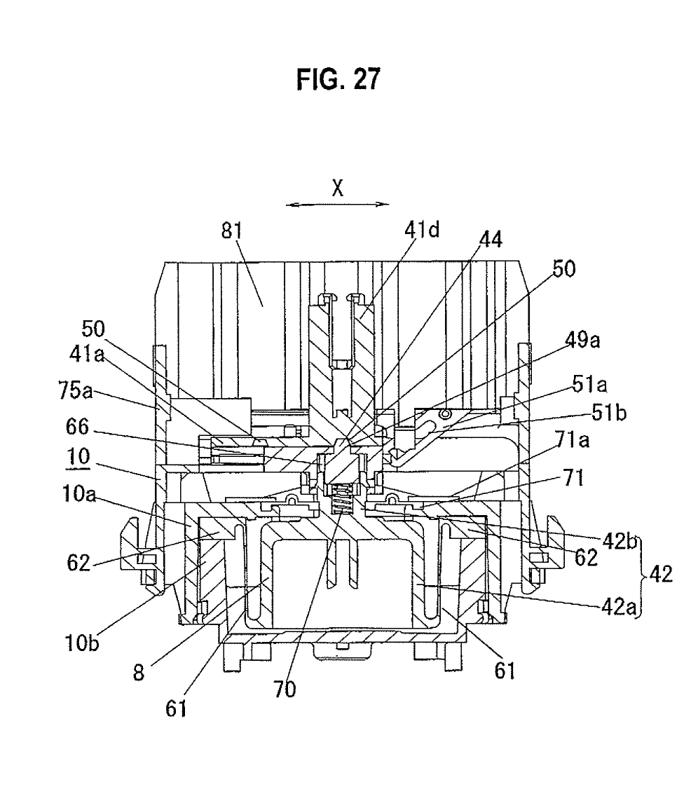

In the present embodiment, as shown in FIG. 17, an upper base 10 includes a blade mounting stage 10a and a drive element base 10b. A motor 11 which is a drive source is mounted on the drive element base 10b. An eccentric cam 60 having an eccentric tip end is press fitted into a motor shaft end. The tip end of the eccentric cam 60 is fitted into a slit formed in the drive element 5. The drive element 8 is provided at its left and right both ends with U-shaped hinge pieces 61 which can be deformed only in one direction. If the drive element base lob is fitted into the blade mounting stage 10a and mounted in a state where a projection 64 provided on the drive element base lob is fitted into a hole 63 formed in the mount piece 62 on the tip end of the hinge piece 61, the mount piece 62 is sandwiched between the blade mounting stage 10a and the drive element base 10b and mounted as shown in FIG. 27, and the drive element 8 reciprocates by rotation of the motor 11 through an eccentric cam 60.

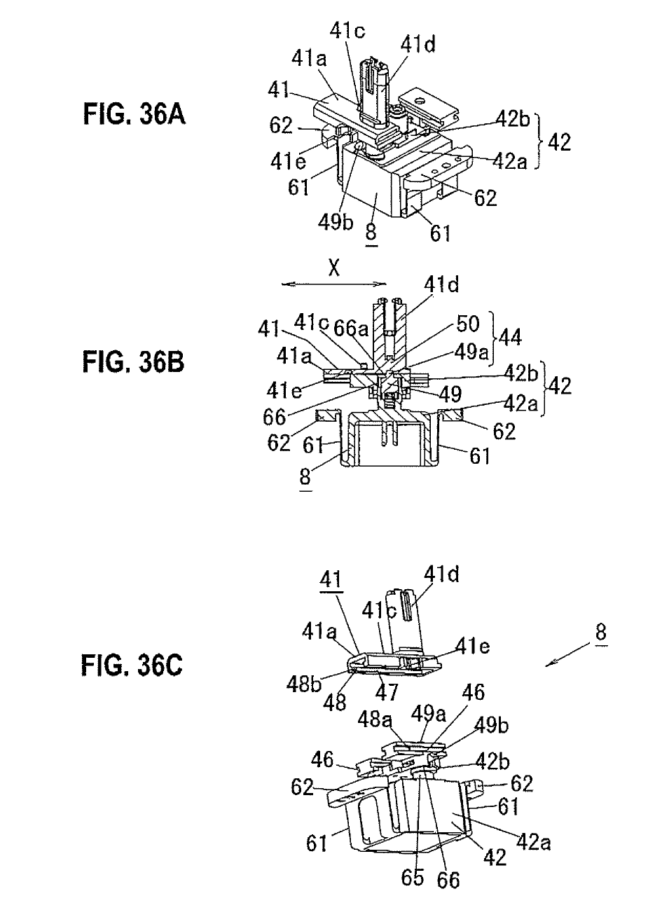

As shown in FIGS. 17 and 36, the drive element 8 is divided into a drive source-side drive element portion 42 on the side of the motor 11 which is the drive source and a movable blade-side drive element portion 41 on the side of the movable blade 39. As will be described later, the movable blade-side drive element portion 41 is mounted such that it can slide in the X direction (lateral direction) which is a reciprocating direction of the movable blade 39 with respect to the drive source-side drive element portion 42.

In the embodiment shown in the accompanying drawings, the drive source-side drive element portion 42 is further divided into a main drive element portion 42a and an auxiliary drive element portion 42b fixed to the main drive element portion 42a. The main drive element portion 42a is provided at its left and right both sides with the hinge pieces 61, and two fitting projections 65 are provided on both front and rear sides (in the direction intersecting with the reciprocating direction of the drive element 8 at right angles) of an upper surface of the main drive element portion 42a. Two fitting holes 66 are formed in both front and rear sides of a lower surface of the auxiliary drive element portion 42b If the fitting projection 65 is fitted into the fitting hole 66, the auxiliary drive element portion 42bis fixed to the main drive element portion 42a. Rails (recesses 46 in the embodiment shown in FIG. 17) are provided on front and rear portions of an upper surface of the auxiliary drive element portion 42b, the rails are long in the lateral direction, and a projecting shaft portion 68 upwardly projects from a central portion of the auxiliary drive element portion 42b. A central cylindrical portion of a drive element lever 69 is rotatably fitted to the projecting shaft portion 68, the drive element lever 69 constitutes a drive element associating unit 43, and the drive element lever 69 applies a spring force which tries to turn the drive element lever 69 in one direction by a spring member 45 including a coil spring.

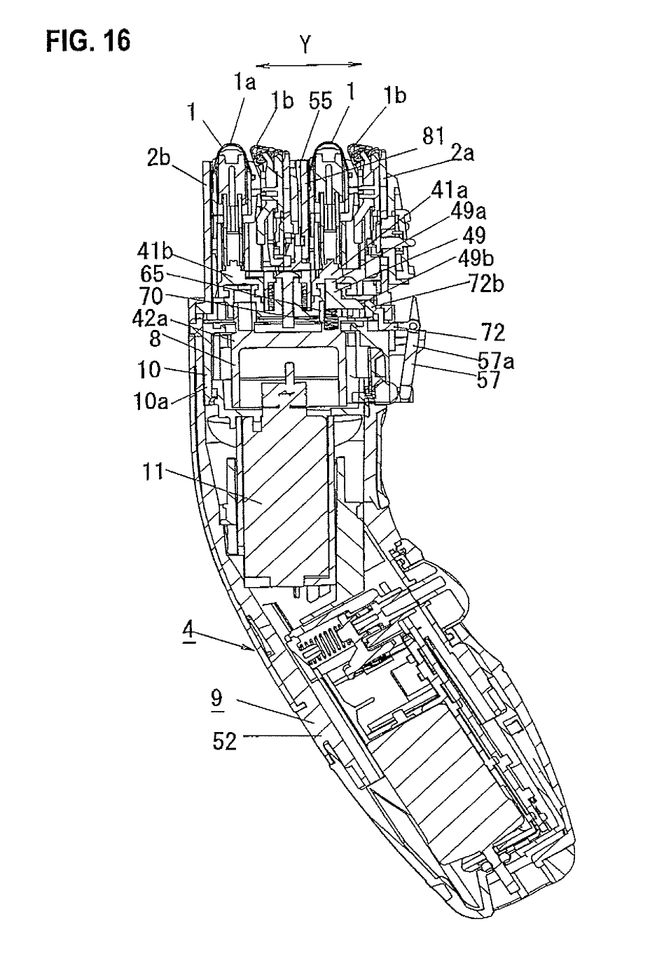

As shown in FIGS. 16 and 17, one of the fitting projections 65 of the main drive element portion 42a is of a cylindrical shape, an upper portion thereof is opened, a drive element lock member 49 and a spring 70 are accommodated in the fitting projection 65 for applying a spring force to resiliently bias the drive element lock member 49, an upper portion of the drive element lock member 49 is vertically movably fitted into a fitting hole 66 formed in the auxiliary drive element portion 42b, and a locking projection 49a projecting upward from an upper surface of the drive element lock member 49 projects upward from a hole 66a formed in an upper surface of the auxiliary drive element portion 42b such that the locking projection 49acan expand and contract. Both side surfaces of the locking projection 49a in the lateral direction are inclined and the locking projection 49a is tapered toward its tip end. The drive element lock member 49 has a projection having an inclined surface 49b. A lower portion of the inclined surface 49b projects more forward.

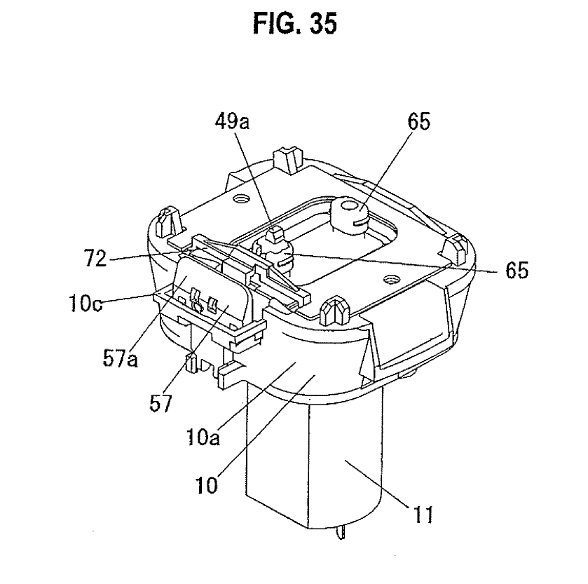

As shown in FIG. 35, a portion of the drive source-side drive element portion 42 which is higher than the fitting projection 65 of the main drive element portion 42a projects from the opening formed in the upper surface of the blade mounting stage 10a. As shown in FIG. 27, a waterproof rubber plate 71 is mounted on the upper surface of the blade mounting stage 10a, the waterproof rubber plate 71 can deform such as to close the opening, a lower portion of the fitting projection 65 of the main drive element portion 42a is fitted into a hole formed in the waterproof rubber plate 71 so that a hole edge of the waterproof rubber plate 71 comes into close contact with the fitting projection 65 resiliently, thereby preventing hair shavings and water from entering the shaver main body 9. The waterproof rubber plate 71 is sandwiched between the press plate 71a and the blade mounting stage 10a by mounting the press plate 71a on the upper surface of the blade mounting stage 10a.

A movable blade-side drive element portion 41 (front movable-side drive element portion 41a and rear movable element-side drive element portion 41b) is mounted on front and rear portions of the auxiliary drive element portion 42b of the drive source-side drive element portion 42 such that the movable blade-side drive element portion 41 can slide in the X direction (lateral direction). In the embodiment shown in the accompanying drawings, as shown in FIGS. 36A to 36C, a laterally long protrusion 47 provided on the movable blade-side drive element portion 41 is slidably mounted by a rail structure which is slidably fitted in a laterally long recess 46 formed in the auxiliary drive element portion 42b and as shown in FIG. 36C, a stopper step 48a is provided on an end of the rail structure, i.e., an end of the recess 46 which becomes a rail, a stopper 48 constituted by projecting a stopper projection 48b from an end of a protrusion 47, and when the protrusion 47 and the recess 46 slide laterally, it the stopper projection 48b abuts against the stopper step 48a, the stopper projection 48b cannot slide further, and this position is a target slide-stop position.

As shown in FIG. 27, two lock holes 50 into which the locking projections 49a projecting from an upper surface of the drive element lock member 49 biased by the spring are formed in the lower surface of the front movable-side drive element portion 41a in a sliding direction (X direction), the drive element lock member 49 having the locking projection 49a biased by this spring and the lock holes 50 constitute a drive element connecting unit 44 which connects the front movable-side drive element portion 41a to the drive source-side drive element portion 42 at the initial position and the sliding position, and by fitting the locking projection 49a into one of the two lock holes 50 corresponding to the initial position, the front movable-side drive element portion 41a is connected and fixed to the drive source-side drive element portion 42 at the initial position, and by fitting the locking projection 49a into the lock hole 50 corresponding to the sliding position, the front movable-side drive element portion 41a is connected and fixed to the drive source-side drive element portion 42 at the sliding position.

As shown in FIG. 27, left and right inner surfaces of the lock hole 50 are inclined such that a lateral width is inclined downward, the locking projection 49a which is tapered toward its tip end is fitted into and locked to the lock hole 50 which whose lateral width is increased downward and thus, if a force greater than a given value is applied in the sliding direction, the locked state is unlocked.

As shown in FIGS. 17, 22, and 30, the drive element lever 69 is provided at its opposite ends with long holes 69a, a projecting shaft portion 41c provided on an upper surf ace portion of the front movable-side drive element portion 41a is slidably fitted into one of the long holes 69a, another projecting shaft portion 41c provided on an upper surf ace portion of the rear movable element-side drive element portion 41b is slidably fitted into the other long hole 69a, and if the fitting state of the locking projection 49a into the lock hole 50 is released in the initial position and the front movable-side drive element portion 41a slides from the initial position to the sliding position (the left sliding position in the drawings), since the projecting shaft portion 41c is slidably fitted into the long hole 69a, the drive element lever 69 turns in one direction, the drive element lever 69 turns, the rear movable element-side drive element portion 41b slides from the initial position to the sliding position (the right sliding position) in association, and if the fitting state of the locking projection 49a in the lock hole 50 is released in the sliding position and the front movable-side drive element portion 41a slides from the sliding position (the left sliding position in the drawing) to the initial position, since the projecting shaft portion 41c is slidably fitted into the long hole 69a, the drive element lever 69 turns in a direction opposite from the above direction, the drive element lever 65 turns, the rear movable element-side drive element portion 41b slides from the sliding position (the right sliding position) to the initial position in association.

Here, a spring force which tries to turn the drive element lever 69 in one direction by the spring member 45 is applied and thus, if the spring member 45 applies a spring force which tries to turn the drive element lever 69 from the initial position to the sliding position, the front movable-side drive element portion 41a slides to the sliding position automatically and the rear movable element-side drive element portion 41b slides to the sliding position in association by releasing the locking projection 49a into the lock hole 50 in the initial position.

When the spring member 45 applies a spring force which tires to turn from the sliding position to the initial position, the front movable-side drive element portion 41a slides to the initial position automatically and the rear movable element-side drive element portion 41b slides to the initial position in association by releasing the locking projection 49a into the lock hole 50 at the sliding position.

In the front and rear movable blade-side drive element portion 41a and movable blade-side drive element portion 41b are superposed in the longitudinal direction when the movable blade 39 supported by the movable blade-side drive element portion 41a and the movable blade 39 supported by the movable blade-side drive element portion 41b substantially correspond in the lateral direction and when they are seen from front.

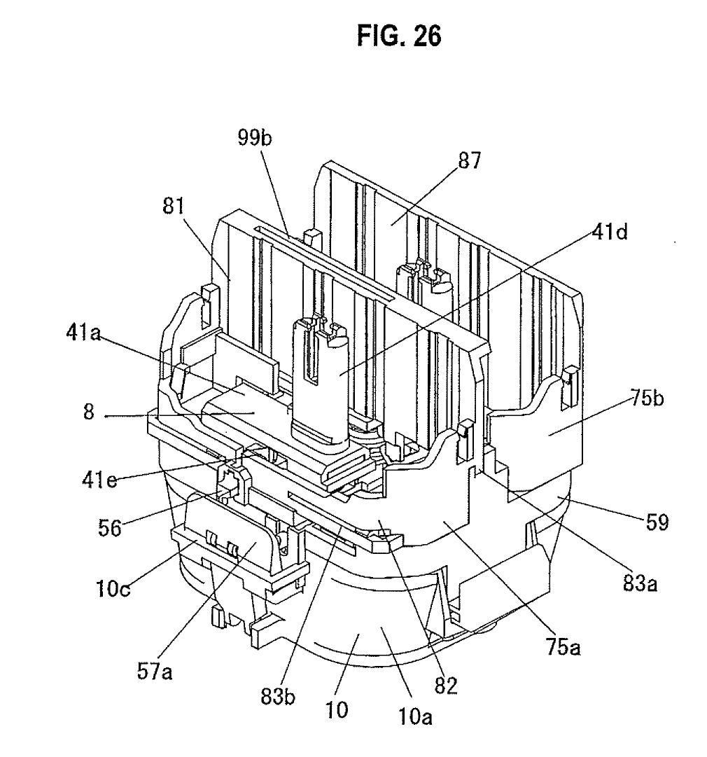

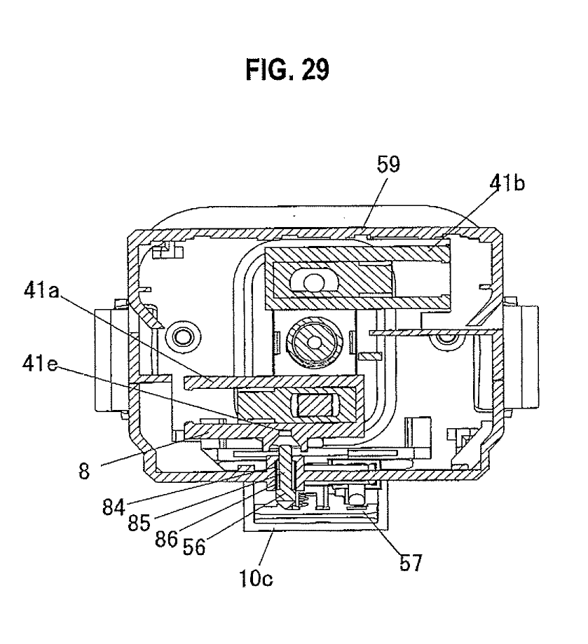

As shown in FIGS. 17 and 26, movable blade mounting portions 41d upwardly project from the front and rear movable blade-side drive element portion 41a and movable blade-side drive element portion 41b. The front movable-side drive element portion 41a is provided at its front surface with a connection hole 41e, and a front portion of the connection hole 41e has a lateral hole width which is increased forward as shown in FIG. 29.

As shown in FIGS. 16, 34, and 35, an operation button 57a constituting an operating unit 57 is mounted on a front surface side of the blade mounting stage 10a. The operation button 57a is turnably supported by the bearing portion 10d provided on a front surface lower portion of the blade mounting stage 10a, and an upper portion of the operation button 57a is inserted into a support frame portion 10c formed on a front surface upper portion of the blade mounting stage 10a such that the upper portion of the operation button 57a cam move in the longitudinal direction. A slide lever 72 is mounted on the blade mounting stage 10a such that the slide lever 72 can slide in the longitudinal direction, a front end of the slide lever 72 is fitted into a vertically long hole formed in the operation button 57a, the slide lever 72 is provided at its rear end surface with an inclined surface 72b which is inclined into an upper and rear direction, the inclined surface 72b and an inclined surface 49b of the locking projection 49a are opposed to each other as shown in FIG. 16, and if the operation button 57a is pushed and operated rearward, the inclined surface 72b of the slide lever 72 moves rearward along the inclined surface 49b of the locking projection 49a, the locking projection 49amoves downward against the spring 70, and the locking projection 49a enters into the hole 66a formed in the upper surface of the auxiliary drive element portion 42b. If the pushing operation of the operation button 57a is released, the drive element lock member 49 moves upward by the spring force of the spring 70, and if the inclined surface 49b pushes, the slide lever 72 moves forward, and the operation button 57a turns forward in the support frame portion 10c.

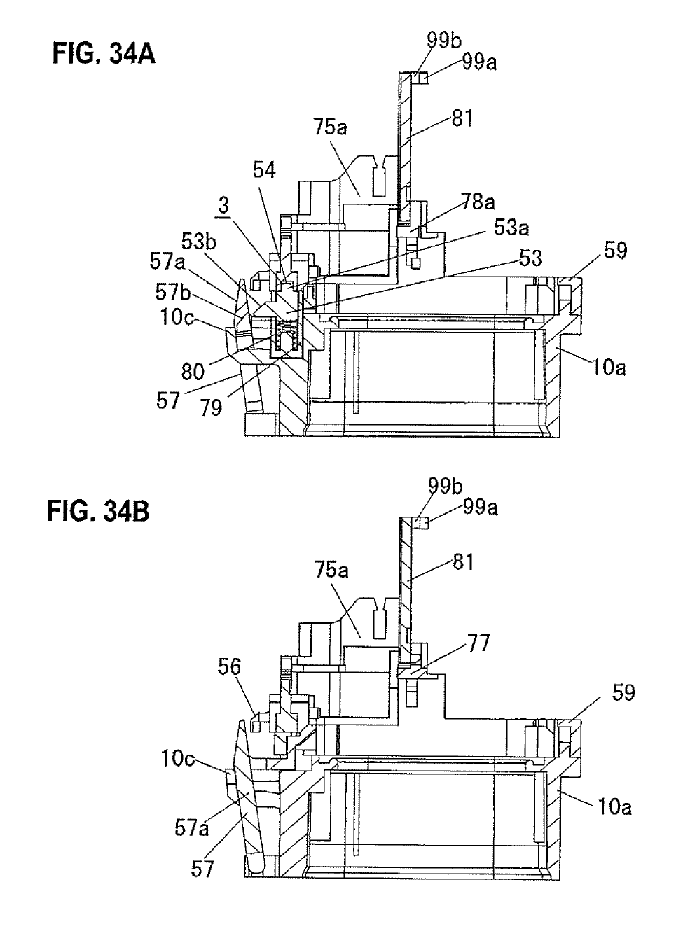

As shown in FIG. 34A, the operation button 57a is provided at its rear surface with an inclined surface 57b which is inclined in an upper and rear direction for operating a later-described frame lock member 53.

A blade head 58 is detachably mounted on the blade mounting stage 10a. The blade head 58 includes a frame base 59, the outer blade frames 2 mounted on the main frame base 59 in the longitudinal direction (the Y direction intersecting with the X direction which is the reciprocating direction of the movable blade 39), and the blade blocks 1 provided on the respective outer blade frames 2 for cutting hair.

At least one of the outer blade frames 2 arranged in the longitudinal direction is mounted on the main frame base 59 such that the outer blade frame 2 can slide in the moving direction of the movable blade 39 from the initial position, and in the embodiment shown in the accompanying drawings, two outer blade frames 2 can slide in different directions (an outer blade frame 2 which slides and an outer blade frame 2 which does not slide can be arranged in the longitudinal direction of course).

Each of the outer blade frames 2 includes the blade block 1. In the present embodiment, an outer blade block 73 and a trimmer block 74 are trimmed on an upper portion of the outer blade frame 2, and the movable blade 39 mounted on the movable blade mounting portion 41d through the spring provided on the movable blade-side drive element portion 41 is disposed in the outer blade frame 2.

As the outer blade frames 2, there exist a front outer blade frame 2a and a rear outer blade frame 2b. Each of the outer blade frames 2 includes a frame main body portion 75 and a cover frame portion 76. That is, the front outer blade frame 2a includes a frame main body portion 75a and a cover frame portion 76a, and a rear outer blade frame 2b includes a frame main body portion 75b and a cover frame portion 76b.

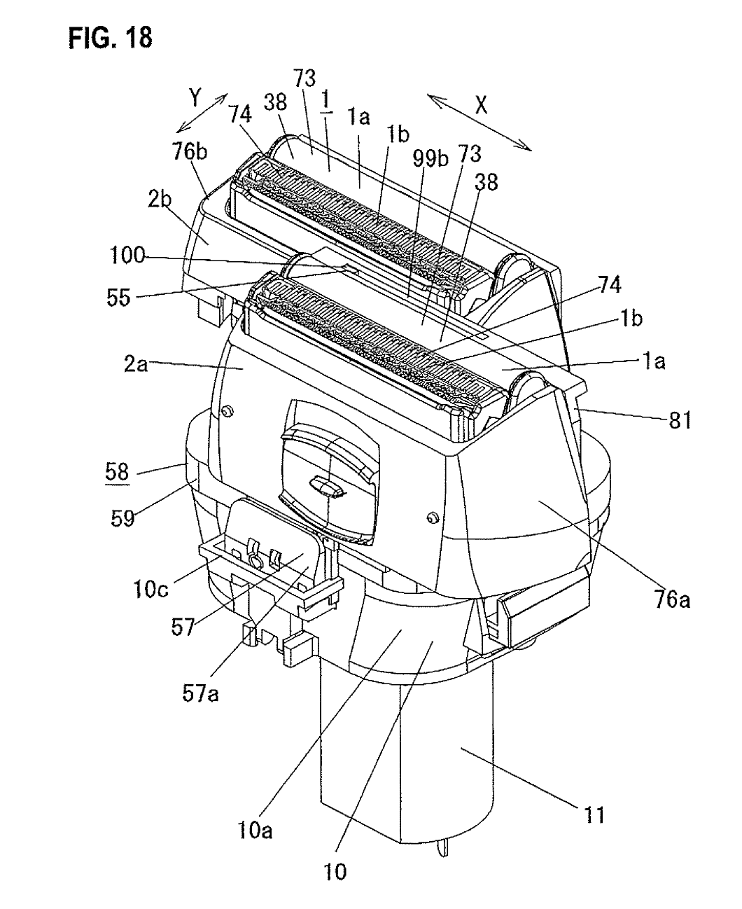

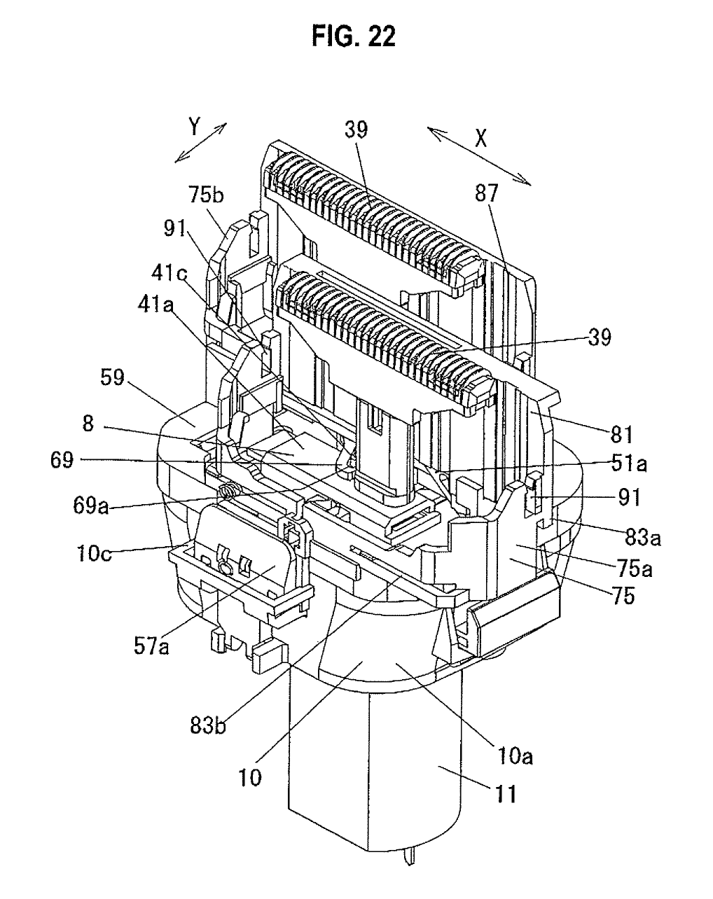

As shown in FIG. 22, the front and rear frame main body portions 75a and 75b are provided at their left and right sides with slit-like notch portions 91, and rib portions (not shown) provided on front and rear frame portions 76a and 7b are vertically movably mounted on the slit-like notch portions 91 (see FIGS. 18 to 20). The outer blade block 73 and the trimmer block 74 are respectively mounted on the front and rear frame portions 76a and 76b.

The outer blade block 73 is provided with a net blade which is an outer blade 38, and if the outer blade 38 reciprocates in a state where the movable blade 39 mounted on the movable blade-side drive element portion 41 through a spring is pushed against a back surface (a lower surface) of the outer blade 38, the outer blade 38 and the movable blade 39 cut hair. The outer blade 38 and the movable blade 39 constitute the short hair cutting blade block 1a.

The trimmer block 74 constituting the long hair cutting blade block 1b is vertically movably mounted on a front cover frame port ion 76a and the rear outer blade frame 2b. The trimmer block 74 includes a slit blade which is an outer blade, and an inner blade which is resiliently pushed against a lower surface of the slit blade by a spring material, the inner blade is detachably connected to the front movable-side drive element portion 41a and a connection portion 93 provided on the rear movable element-side drive element portion 41b, and if the front movable-side drive element portion 41a and the rear movable element-side drive element portion 41b reciprocate, the inner blade of the trimmer block 74 also reciprocates.

In the embodiment shown in the accompanying drawings, the front outer blade frame 2a and the rear outer blade frame 2b are mounted on the main frame base 59 such that they can slide in the lateral direction X (moving direction of the movable blade 39).

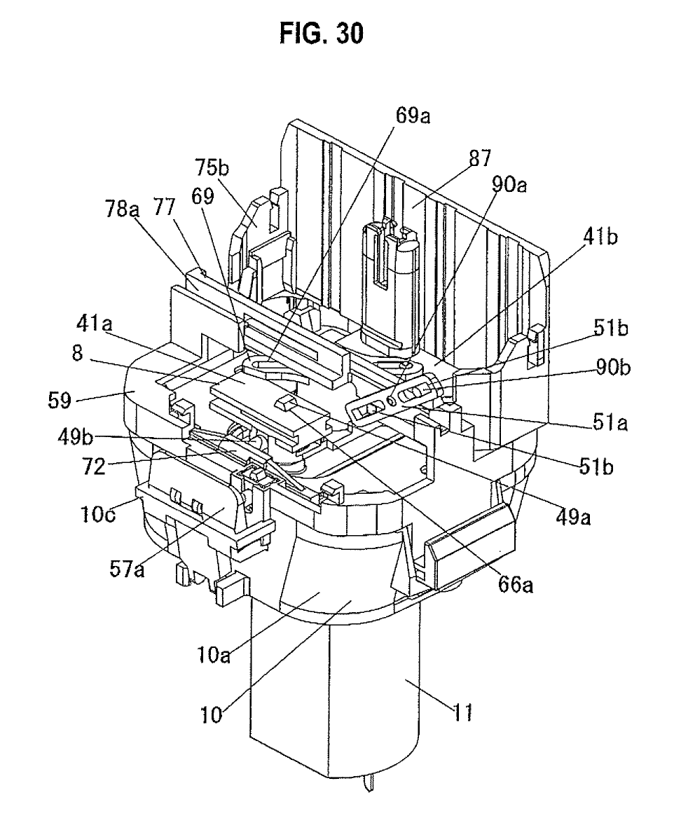

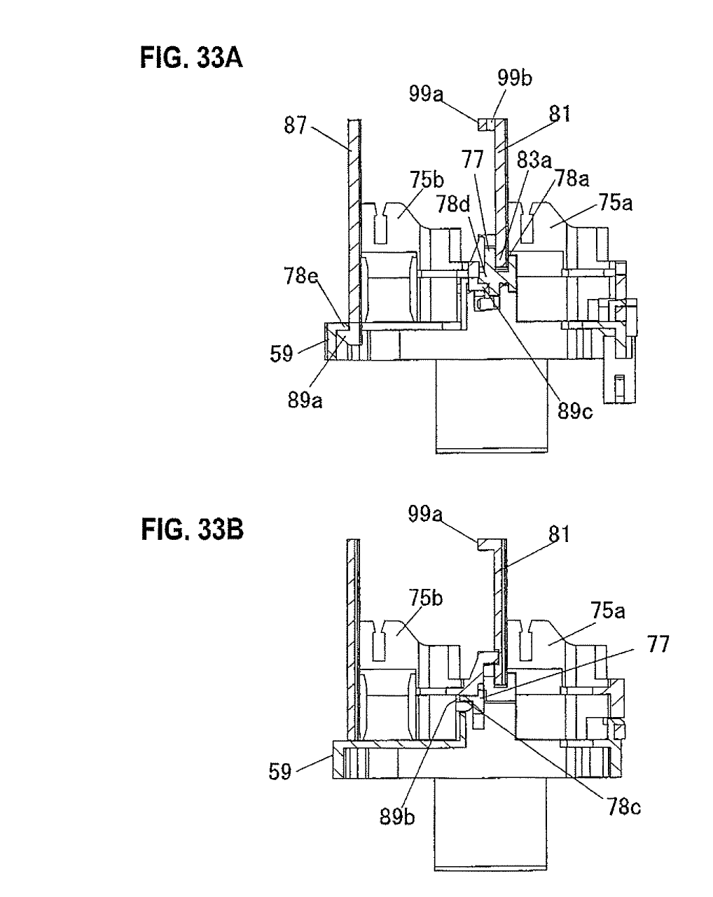

The main frame base 59 is of a square frame shape, and as shown in FIG. 17, the main frame base 59 is provided with a central bridging piece 77 which bridges longitudinal central portions in the lateral direction, a rail portion 78a whose upper portion is opened is provided on substantially half (left side in the embodiment) in the lateral direction of a front side of the central bridging piece 77, a slide projection 78b which is of reversed L-shape in the lateral direction upwardly projects from a front upper surface of the square frame shaped main frame base 59, a slide projection 78c is provided on one side (right side in the embodiment) of a rear surface of the central bridging piece 77 as shown in FIG. 33, a slide rail portion 78d is provided on one side (left side in the embodiment) of the rear surface in the lateral direction, and a rear slide rail portion 78e is provided on a rear portion of the square frame-shaped main frame base 59. Further, a cylindrical portion 79 is provided on a central portion of a front portion of the square frame-shaped main frame base 59 in the lateral direction. As shown in FIG. 30, an association lever 51a constituting an outer blade frame associating unit 51 is mounted on other side half portion (right side in the embodiment) on which a rail portion 78a of the central bridging piece 77 is not provided such that a central portion of the association lever 51a can turn on a vertical plane. The association lever 51a is formed at its both ends with long holes 51b.

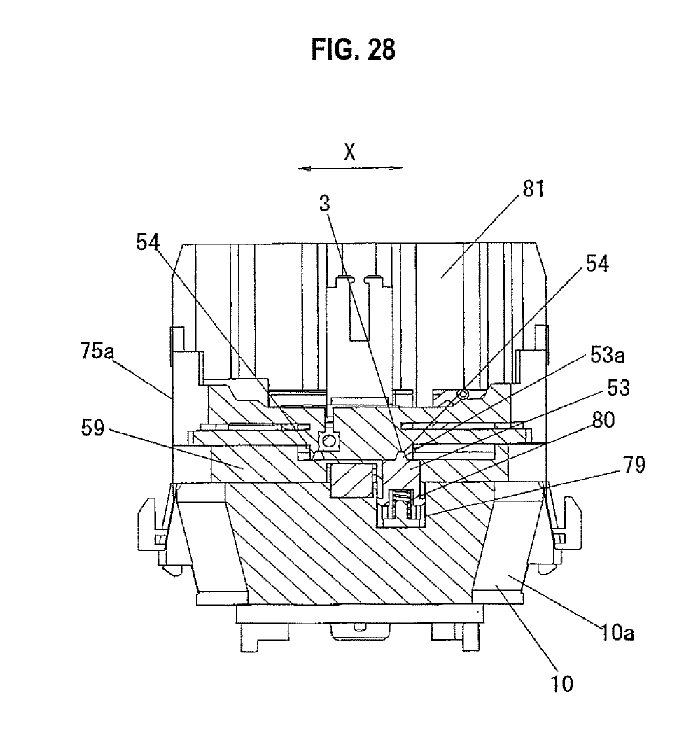

As shown in FIG. 28, a frame lock member 53 and a spring 80 for resiliently biasing the frame lock member 53 upward are accommodated in the cylindrical portion 79, and an upper portion of the frame lock member 53 can project from an upper opening of the cylindrical portion 79. A locking projection 53aprojects upward from an upper surface of the frame lock member 53, and both side surfaces of the locking projection 53a in the lateral direction are inclined and tapered toward their tip end. A projection having am inclined surface 53b projects from the frame lock member 53, the inclined surface 53b is inclined into a lower and front direction, and the projection projects forward from a vertical slit formed in a front surface of the cylindrical portion 73.

As shown in FIG. 34A, the inclined surface 53b provided on the frame lock member 53 is opposed to the inclined surface 57b provided on a rear surface of the operation button 57a, and it the operation button 57a is pushed rearward, the inclined surface 57b moves rearward to push the inclined surface 53b downward, and the frame lock member 53 is moved downward. If the pushing operation of the operation button 57a is released, the frame lock member 53 moves upward by a spring force of the spring 80, the inclined surface 53b moves upward, the inclined surface 57b is pushed forward, and the operation button 57a moves forward.

The front outer blade frame 2a is constituted by mounting the cover frame portion 76a on the frame main body portion 75a.

As shown in FIGS. 17, 26, and 32 , the frame main body portion 75a integrally provided with a U-shaped frame portion 82 which projects forward from a lower end of a vertical front wall plate portion 81. A lower end of the front wall plate portion 81 projects below a portion to which the frame portion 82 of the front wall plate portion 81 is connected, and this portion is a rail fitting portion 83a . Rail portions 83b which are long in the lateral direction are provided on left and right portions of a front portion of the frame portion 82. Further, as shown in FIGS. 17 and 29, a hole portion 84 is formed in a central portion of a front portion of the frame portion 82 in the lateral direction, a rear portion of the connection pin 85 and a spring 86 for applying a spring force which tries to project the connection pin 85 forward are inserted into the hole portion 84, the rear end of the connection pin 85 is in the hole portion 84 by the spring 86 in a normal state, but if the connection pin 85 is pushed rearward against the spring 86, the rear end can project rearward from the hole portion 84, and when it projects rearward, the rear end of the connection pin as can be fitted into the connection hole 41e. The connection pin 85, the spring 86 and the connection hole 41e constitute the connecting member 56 which is detachably connect the movable blade-side drive element portion 41 and the outer blade frame 2 to the outer blade frame 2. As shown in FIG. 28, locking holes 54 to which locking projections 53 projecting from-upper surface of the frame lock member 53 biased by the spring are formed in two locations of a front lower surface of the frame portion 82 in the lateral direction (sliding direction). The two locking holes 54 in the lateral direction have the same pitches as those of the two lock holes 50 formed in the movable blade-side drive element portion 41a.

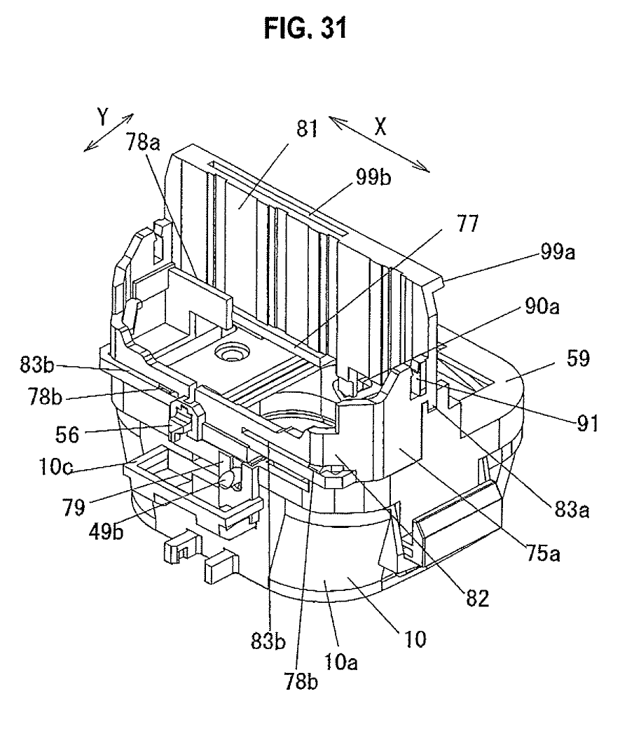

As shown in FIG. 31, the rail fitting portion 83a of the frame main body portion 75a is slidably fitted into the rail portion 78a, and the slide projection 78b is slidably fitted into the rail portion 83b. With this configuration, the frame main body portion 75a is slidably mounted on a front half portion of the main frame base 59 in the lateral direction.

The locking hole 54 and the frame lock member 53 which is biased by the spring and which has the locking projection 53a constitute the fixing unit 3. The locking projection 53a is fitted into one of the two locking holes 54 corresponding to the initial position, the frame main body portion 75a (i.e., the frame main body portion 75) is connected to and fixed to the front portion of the main frame base 59, the locking projection 53a is fitted into one of the two locking holes 54 corresponding to the sliding position, the frame main body portion 75a (i.e., the frame main body portion 75) is connected to and fixed to the front portion of the main frame base 59.

Here, as shown in FIG. 28, left and right inner surfaces of the locking hole 54 are inclined such that the lateral width is increased downward, the locking projection 53a which is tapered toward its tip end is fitted into the locking hole 54 whose lateral width is increased downward and locked and thus, if a force greater than a given value is applied in the sliding direction, the looked state is released.

The rear outer blade frame 2b is constituted by the frame main body portion 75b and the cover frame portion 76b.

As shown in FIG. 17, the rear frame main body portion 75b is integrally provided with a U-shaped frame portion 88 which forwardly projects from a lower end of a vertical rear wall plate portion 87. As shown in FIGS. 33A and 33B, a slide retaining unit 89a projects rearward from a lower end of the rear wall plate portion 87, a rail groove portion 89b is provided on a substantially one side half portion (left side in the embodiment) of a front end of the frame portion 88, and a slide projection 89c is provided on a front end of the frame portion 88.

As shown in FIGS. 33A and 33B, the slide retaining unit 89a of the rear frame main body portion 75b is slidably retained to the rear slide rail portion 78e of the main frame base 59, the slide projection 78c is slidably fitted into the rail groove portion 89b, and the slide projection 89c is slidably fitted into the slide rail portion 78d. With this configuration, the frame main body portion 75b is mounted on a rear half portion of the main frame base 59 such that the frame main body portion 75 can slide in the lateral direction.

The long hole 51b formed in one end of the association lever 51a which is turnably mounted on the central bridging piece 77 is fitted over a shaft portion 90a formed on a front end of the frame portion 88 of the rear frame main body portion 75b such that the long hole 51b can slide and turn, the long hole Sib formed in the other end of the association lever 51a is slidably and turnably fitted over a shaft portion 90b projecting from a rear surface of the front wall plate portion 81 of the frame main body portion 75a, and if the frame main body portion 75a (i.e., the front outer blade frame 2a) slides, the frame main body portion 75b (i.e., rear outer blade frame 2b) is slid in the opposite direction through the association lever 51a in association.

That is, in the initial position, the operation button 57a is rearwardly pushed to release the fitting state of the locking projection 53a with respect to the locking hole 54, and if the front outer blade frame 2a slides from the initial position to the sliding position (the left sliding position in the drawings), since the shaft portions 90a and 90b are slidably fitted to the long holes 51bthe association lever 51a turns in one direction, the association lever 51a turns, the rear outer blade frame 2b slides from the initial position to the sliding position (the right sliding position) in association, and in the sliding position, the operation button 57a is rearwardly pushed to release the fitting state of the locking projection 53a with respect to the locking hole 54, and if the front outer blade frame 2a slides from the sliding position (the left sliding position in the drawings) to the initial position, since the shaft portions 90a and 90b are slidably fitted into the long holes 51b, the association lever 51a turns in the opposite direction, the association lever 51a turns, and the rear outer blade frame 2b slides from the sliding position (the right sliding position) to the initial position in association.

Here, when the operation button 57a is pushed in the initial position and the sliding position, the locking projection 53a is fitted into the locking hole 54 and the front outer blade frame 2a is fixed such that it cannot slide with respect to the main frame base 59, the rear outer blade frame 2b connected through the association lever 51a is fixed such that it cannot slide with respect to the main frame base 59, the locking projection 49a is fitted into the lock hole 50, the front movable-side drive element portion 41a is fixed such that it cannot slide with respect to the drive source-side drive element portion 42, and the rear movable element-side drive element portion 41b connected through the drive element lever 69 is fixed such that it cannot slide with respect to the drive source-side drive element portion 42.

The front end of the connection pin 85 is in abutment against or is close to a rear surface of the operation button 57a, and a state where the operation button 57a is not pushed rearward, the rear end of the connection pin 85 is not fitted into the connection hole 41e formed in the front movable-side drive element portion 41a.

Therefore, in a state where the operation button 57a is not operated in any of the initial position and the sliding position and the front and rear outer blade frames 2a and 2b are fixed to the main frame base 59 and the front and rear movable blade-side drive element portions 41a and 41b are fixed to the drive source-side drive element portion 42, the front movable-side drive element portion 41a which supports the movable blade 39 at the upper end reciprocates in the front outer blade frame 2a, the rear movable blade-side drive element portion 41b which supports the movable blade 39 at the upper end reciprocates in the rear outer blade frame 2b, and the reciprocating movable blade 39 and outer blade 38 cut hair.

In the initial position and the sliding position, if the operation button 57a is rearwardly pushed and the connection between the locking hole 54 and the locking projection 53a is released and the connection between the lock hole 50 and the locking projection 49a is released, the connection in 85 is pushed rearward against the spring 86 at the same time, the rear end of the connection pin 85 is fitted into the connection hole 41e of the front movable-side drive element portion 41a, and the front outer blade frame 2a and the front movable-side drive element portion 41a are connected to each other. Therefore, in the initial position and the sliding position, in a state where the operation button 57a is pushed rearward, the front outer blade frame 2a and the front movable-side drive element portion 41a slide in association. At that time, the front outer blade frame 2a and the rear outer blade frame 2b are associated with each other, and the front movable-side drive element portion 41a and the rear movable element-side drive element portion 41b are associated with each other Therefore, the front and rear outer blade frames 2a and 2b and the front and rear movable blade-side drive element portions 41a and 41b slide in association.

When the operation button 57a is pushed to fit the connection pin 85 into the connection hole 41e, since the movable blade-side drive element portion 41a disposed such as to reciprocate in the front outer blade frame 2a is stopped at an arbitrary position in the reciprocating range, the stop position of the-movable blade-side drive element portion 41a in the outer blade frame 2ais not constant in any of the initial position and sliding position, and the connection hole 41e and the connection pin 85 do not always coincident. Hence, in the present invention, the front portion of the connection hole 41e is formed such that the lateral hole width is increased forward as shown in FIG. 29 so that even when the connection pin 85 and the connection hole 41e are slightly deviated, the connection pin as can smoothly enter the entrance of the connection hole 41e having wide width (i.e., widened in ˆ-shaped).

In the present invention, there is provided an arrangement direction position holding unit 55 which holds a positional relationship in the arrangement direction of the arranged outer blade frames 2. That is, as shown in FIGS. 16, 17, 18, and 19, a convex stripe portion 99a projects rearward from an upper end of the front wall plate portion 81 of the frame main body portion 75a, and the convex stripe portion 99a is provided with a long hole 99b which is long in the sliding position (X direction). The rear cover frame portion 76b is provided at its front surface with a projection 100 which projects upward, and a tip end of the projection 100 is slidably fitted into the long hole 99b. The arrangement direction position holding unit 55 includes the long hole 99b and the projection 100, the arranged front and rear outer blade frames 2a and 2b are prevented from opening or narrowing in the arrangement direction, the front and rear outer blade frames 2a and 2b can stably be used in a using mode where the shaving area width M is widened and in a using mode where the shaving area width M is narrowed, and the sliding motion can be stably and smoothly carried out.

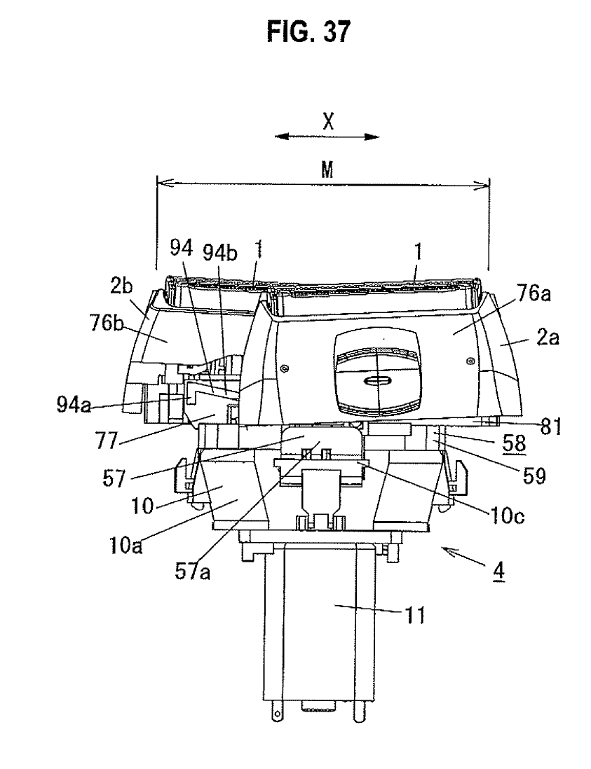

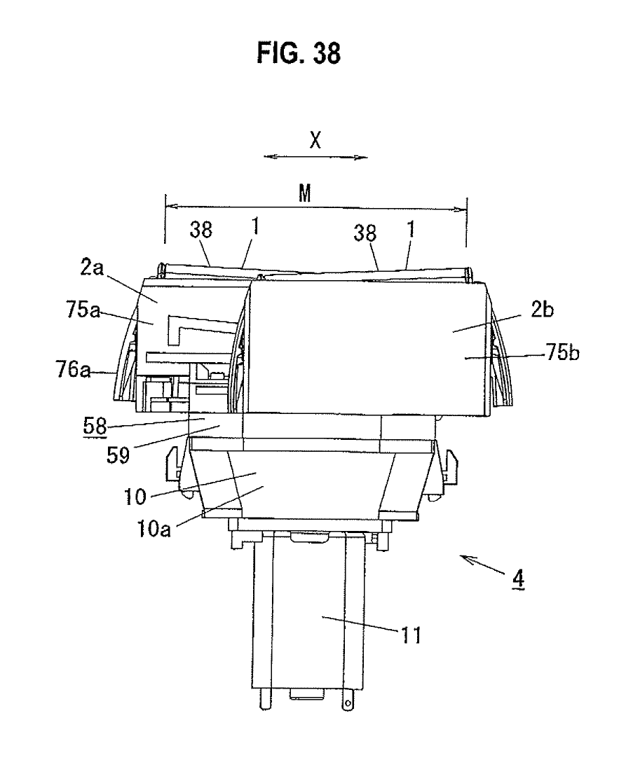

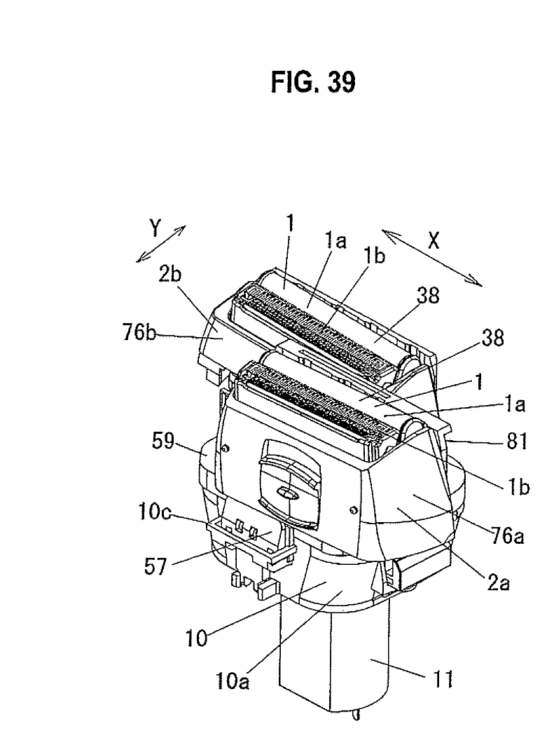

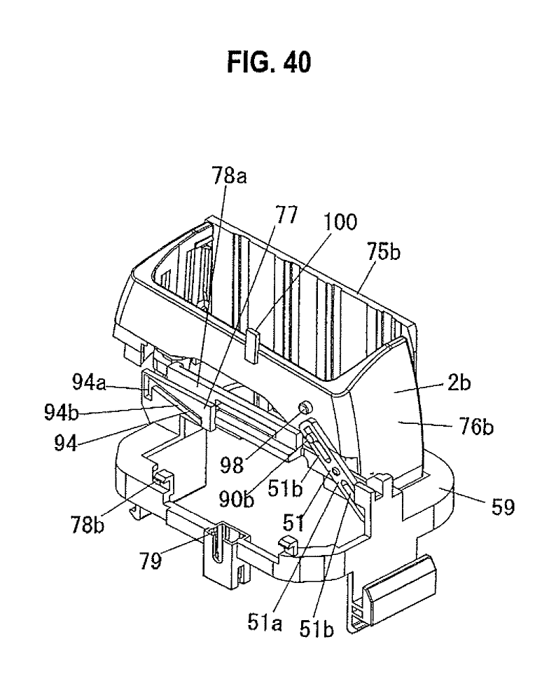

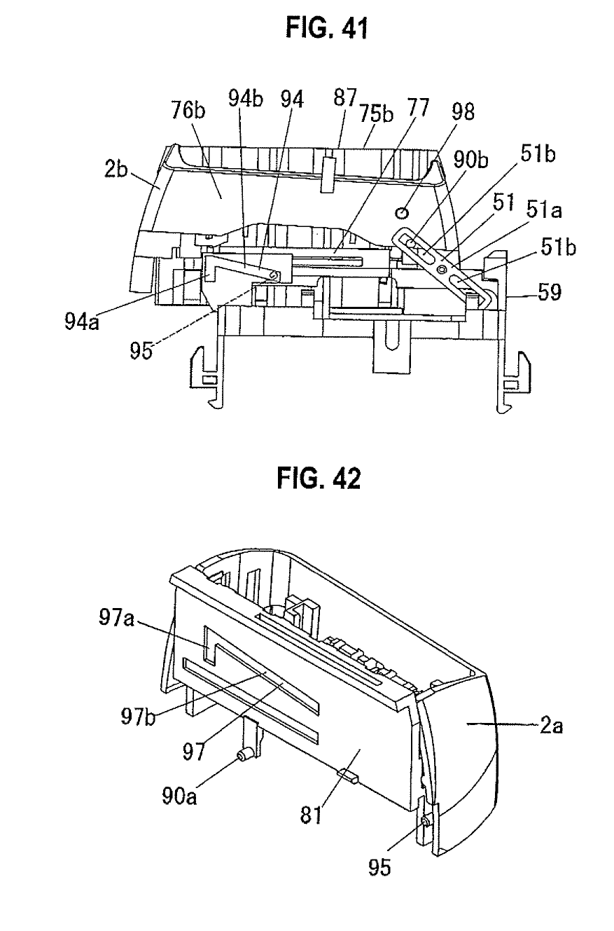

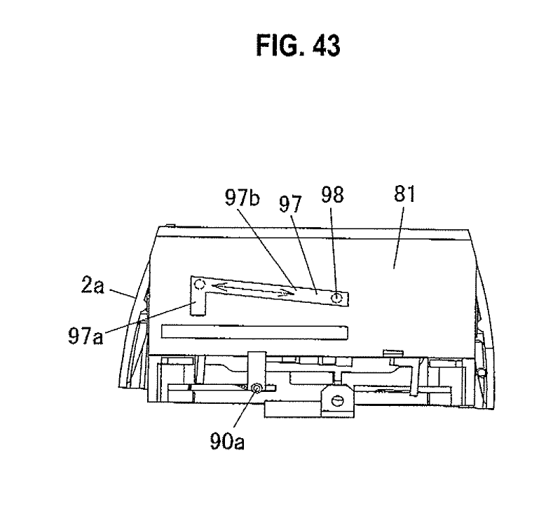

FIGS. 37 to 43 show another embodiment of the present invention.

In the above embodiment, the outer blade frames 2 are slid and arranged in the moving direction of the movable blade 39 from the initial position, and the shaving area width M is widened by the outer blade 38 which holds the outer blade frames 2. In this state, the arranged outer blade frames 2 are in parallel to each other. In the present embodiment, in a state where the shaving area width M is widened by the outer blade 38 which is held by the outer blade frames 2 which slide in the moving direction of the movable blade 39 from the initial position and arranged, as shown in FIGS. 37 to 39, the arranged outer blade frames 2 slide and incline with respect to the initial position such that the arranged outer blade 38 projects further from central portions of the both ends of the shaving area width M. With this configuration, when the shaving area width M is widened and hair of an arm or a leg is to be cut, the outer blade easily come into close contact with a curved surface of the arm or the leg and the amount of hair which is left unshaved is small, and the shaving operation can he swiftly carried out.

Here, the arranged entire outer blade frames 2 may incline at the sliding position or a portion of constituent members of the arranged outer blade frames 2 may incline at the sliding position.

In the embodiment shown in FIGS. 37 to 43, the portion of the constituent members of the arranged outer blade frames is inclined at the sliding position.

That is, like the previous embodiment, the frame main body portion 75a and the rear frame main body portion 75b are mounted on the main frame base 59 such that they can slide in the lateral direction, they slide while keeping the parallel relationship, the front cover frame portion 76a is mounted such that it can vertically move within a constant range with respect to the frame main body portion 75a, and the rear cover frame portion 76b is mounted such that it can vertically move within a constant range with respect to the frame main body portion 75b.

The central bridging piece 77 extends at a central portion of the main frame base 59 in the longitudinal direction, a taper guide portion 94 including a vertical groove 94a and an inclined groove 94b (inclined downward as separating away from the vertical groove 94a) which is in communication with an upper end of the vertical groove 94a is provided on a front surface side of one end of the central bridging piece 77 in the lateral direction as shown in FIGS. 37, 40, and 41, and a projection 95 provided on a rear end of a left or right end of the front cover frame portion 76a is movably fitted to the taper guide portion 94. In a state where the front cover frame portion 76a is located at the initial position, the projection 95 is located at an upper end of the inclined groove 94b (upper end of the vertical groove 94a), and in a state where the front cover frame portion 76a is located at the sliding position, the projection 95 is located at a lower end of the inclined groove 94b. In a state where the front cover frame portion 76a is located at the initial position, the front cover frame portion 76a is in parallel to the frame main body portion 75a which slides with respect to the main frame base 59 and thus, in a state where the front cover frame portion 76a is located at the sliding position, the front cover frame portion 76a is inclined with respect to the sliding direction (state where the end opposite from the slide moving direction is inclined downward).

As shown in FIGS. 30, 42, and 43, the frame main body portion 75a is provided at its rear surface with a taper guide portion 97 including a vertical groove 97a and an inclined groove 97b (inclined downward as separating away from the vertical groove 97a) which is in communication with an upper end of the vertical groove 97a, and a projection 98 provided on a right or left end of a front surface of the rear cover frame portion 76b is movably fitted to the taper guide portion 97. In a state where the rear cover frame portion 76a is located at the initial position, the projection 98 is located at an upper end of the inclined groove 97b (an upper end of the vertical groove 97a), and in a state where the rear cover frame portion 76b is located at the sliding position, the projection 98 is located at a lower end of the inclined groove 97b. In a state where the rear cover frame portion 76b is located at the initial position, the rear cover frame portion 76b is in parallel to the rear frame main body portion 75b which slides with respect to the main frame base 59 and thus, in a state where the rear cover frame portion 76b is located at the sliding position, the rear cover frame portion 76b is inclined with respect to the sliding direction (a state where the end opposite from the slide moving direction is inclined downward).

With the above configuration, in a using mode in which the front and rear outer blade frames 2a and 2b are located at the initial positions and the shaving area width M is the narrowest (short) that can be shaved at a time by the entire blade block 1, the outer blades 38 (and a trimmer blade) provided on the outer blade frames 2a and 2b are in parallel, and it is possible to effectively cut hair at a location where the shaving area is narrow such as an armpit.

As shown in FIGS. 37 to 39, in a state where the front and rear outer blade frames 2a and 2b are slid in the opposite directions from each other, i.e. , in a using mode where the shaving area width M that can be shaved at a time by the entire blade block 1 is the widest (long), the outer blades 38 (and trimmer blades) provided on the outer blade frames 2a and 2b are inclined such that both ends of the shaving area width M project more than its central portion. Thus, when the shaving area width M is widened and hair of an arm or a leg is to be cut, the outer blade easily come into close contact with a curved surface of the arm or the leg and the amount of hair which is left shaved is small, and the shaving operation can be swiftly carried out.

Since the taper guide portion 94 is provided with the vertical groove 94a and the taper guide portion 97 is provided with the vertical groove 97a, even when a pushing down force is applied to the outer blade 38 from above in a state where the front and rear outer blade frames 2a and 2b are located at the initial positions, the projections 95 and 98 can move along the vertical rove 94a and the vertical groove 97a, and the outer blade 38 can float.

According to the invention, in any of a narrow portion such as an armpit and a wide portion such as a leg or an arm, the shaving width of the shaver blade can assume a shaving area width optimal for the respective portions, the blade can easily come into contact with a skin in the narrow portion such as the armpit and hair can be cut smoothly and swiftly, and using comfort is excellent, and in the wide portion such as the leg and the arm, the amount of hair that can be shaved with one stroke is increased and hair can be shaved swiftly, and since the outer blade frame is fixed by the fixing unit at the sliding position, hair can be cut in a state where a shaving area width set by the slide is maintained when the shaver is used in a state where the outer blade frame is slid, and there is an effect that hair can be cut stably and reliably.

Although the invention is not limited to the embodiments described above. Modifications and variations of the embodiments described above will occur to those skilled in the art, in light of the teachings. The scope of the invention is defined with reference to the following claims.

What is claimed is:

1. A shaver comprising a plurality of outer blade frames each having a blade block for cutting hair, wherein the outer blade frames are arranged in a direction perpendicular to a moving direction of a movable blade of the blade block, at least one of the outer blade frames can slide in the moving direction of the movable blade from an initial position, and the shaver further comprises a fixing unit for fixing the outer blade frame at a sliding position.

2. The shaver according to claim 1, wherein the outer blade frames can slide in different directions.

3. The shaver according to claim 1, wherein at least one of the outer blade frames can slide, each of the outer blade frames has the blade block, the movable blade of the blade block is driven by one drive source.

4. The shaver according to claim 1, wherein a drive element which is driven by a drive source and which reciprocates the movable blade is divided into a drive source-side drive element portion on a drive source side and a movable blade-side drive element portion on a movable blade side, the movable blade-side drive element portion is mounted on the drive source-side drive element portion such that the movable blade-side drive element portion can slide in a reciprocating direction of the movable blade.

5. The shaver according to claim 4, wherein a plurality of movable blade-side drive element portions slide in association by a drive element associating unit.

6. The shaver according to claim 4, further comprising a drive element connecting unit which connects the movable blade-side drive element portion and the drive source-side drive element portion, and a spring member which slides the movable blade-side drive element portion from the initial position to a sliding position or from the sliding position to the initial position with respect to the drive source-side drive element portion.

7. The shaver according to claim 4, where the movable blade-side drive element portion and the drive source-side drive element portion can slide by a rail structure comprising a recess and a protrusion, the rail structure is provided at its end with a stopper for a sliding motion.

8. The shaver according to claim 4, wherein the drive element connecting unit comprises a drive element lock member which is biased by a spring provided on the drive source-side drive element portion, and a lock hole into which the drive element lock member provided on the movable blade-side drive element portion can be fitted, the drive element lock member is fitted into the lock hole and a position of slide of the movable blade-side drive element portion is fixed.

9. The shaver according to claim 2, wherein the plurality of outer blade frames slide by an outer blade frame associating unit in association.

10. The shaver according to claim 1, wherein the outer blade frame is mounted on a shaver main body such that the outer blade frame can slide in a reciprocating direction of the movable blade, the fixing unit of the outer blade frame comprises a frame lock member biased by a spring provided on the side of the shaver main body, and a lock hole into which the frame lock member provided on the outer blade frame can be fitted, the frame lock member is fitted into the lock hole and a slide position of the outer blade frame is fixed.

11. The shaver according to claim 2, further comprising an arrangement direction position holding unit which holds a positional relationship of the arranged outer blade frames in an arrangement direction.

12. The shaver according to claim 2, wherein the outer blade frame is provided with a connecting member which detachably connects the movable blade-side drive element portion and the outer blade frame with each other, the outer blade frame and the movable blade-side drive element portion can slide simultaneously in a state where the outer blade frame and the movable blade-slide drive element portion are connected to each other by the connecting member, and the movable blade-side drive element portion can reciprocate in the outer blade frame in a state where the outer blade frame and the movable blade-side drive element portion are not connected to each other by the connecting member.

13. The shaver according to claim 12, further comprising a common operating unit which releases the connection between the movable blade-side drive element portion and the drive source-side drive element portion established by the drive element connecting unit, releases the connection between the shaver main body and the outer blade frame established by the fixing unit of the outer blade frame, and connects the movable blade-side drive element portion and the outer blade frame to each other by the connecting member.

14. The shaver according to claim 1, wherein in a state where the outer blade frame is slid in the moving direction of the movable blade from the initial position, a shaving area width established by the outer blade held by the arranged outer blade frames is widened, the arranged outer blades are formed such that both ends of the shaving area width M project more than a central portion thereof.

15. The shaver according to claim 1, wherein further comprising an output side gear which outputs a driving force, a drive gear to which rotation is transmitted from the output side gear and which rotates, a drive element which converts the rotation of the drive gear into a reciprocating motion through an eccentric cam and which reciprocates the movable blade of the outer blade frame, a plurality of output side gears, wherein the drive gear, the eccentric cam and the drive element slide together with the outer blade frame, the driving force is transmitted to the drive gear through different output side gears in the initial position and the sliding position of the outer blade frame.
